(19) United States
(12) Patent Application Publication
(10) Pub. No.: US 2020/0337232 A1
(43) Pub. Date: Oct. 29, 2020

(54) INFORMATION INFERENCE FOR AGRONOMIC DATA GENERATION IN SUGARCANE APPLICATIONS

(71) Applicant: Deere & Company, Moline, IL (US)

(72) Inventors: Sebastian Blank, Moline, IL (US); Peter A. Johnson, Thibodaux, LA (US); John A. Dighton, Thibodaux, LA (US)

(21) Appl. No.: 16/393,364

(22) Filed: Apr. 24, 2019

(51) Int. Cl. A01D 41/127; A01M 21/04; A01C 21/00; A01M 7/00; A01D 45/10; G01F 1/00

(52) U.S. Cl. CPC A01D 41/127; A01M 21/043; G01F 1/00; A01M 7/0089; A01D 45/10; A01C 21/007

(57) ABSTRACT

A method for mapping an agricultural crop in a field is provided. The method comprising receiving signals, with a control unit on an agricultural machine, from a yield sensor, which senses a yield characteristic of the crop, and a processing sensor, which senses a processing characteristic of the crop, associated with an agricultural work machine; determining the presence of a void crop plant using the received signals; determining a location of the void crop plant using at least a time and a location of the agricultural work machine; and generating a void crop map showing the location of the void crop within the field.

### FIELD OF THE DISCLOSURE

The present disclosure relates generally to sensor fusion system for a sugarcane harvester, wherein the sensor fusion system is used to detect and map one or more void crop plants and one or more crop yields.

### BACKGROUND OF THE DISCLOSURE

In many applications, it can be important to know an operating state of an agricultural work machine. Current systems combine values from several sensors to determine the operating state of the machine that may vary over time to automatically control components of the work machine. However, for numerous reasons signals from one such sensor can be less reliable than those from another sensor, be it due to the type of sensor, operating state, conditions, failure or signal degradation. For example, some sensors, e.g., trash or leaf sensors, are less reliable in high throughput or high moisture conditions than in low throughput or dry conditions.

### SUMMARY OF THE DISCLOSURE

A method for mapping an agricultural crop in a field, the method comprising: receiving signals, with a control unit on an agricultural machine, from a yield sensor, which senses a yield characteristic of the crop, and a processing sensor, which senses a processing characteristic of the crop, associated with an agricultural work machine; determining the presence of a void crop plant using the received signals; determining a location of the void crop plant using at least a time and a location of the agricultural work machine; and generating a void crop map showing the location of the void crop within the field.

The method may further comprise classifying the received signals using at least one of a fuzzy logic, machine learning, clustering or statistical analysis classification system.

The method wherein the step of classifying the received signal is performed using a fuzzy logic system wherein a confidence factor is assigned to each of the received signals associated with the yield sensor and processing sensor for a sampling interval.

The method may further comprise determining an aggregate confidence indicator for the presence of a void crop plant based on the confidence factors related to an estimated accurateness of the received signal.

The estimated accurateness of the received signal may be based on at least one of (i) a range of the at least one of the received signals, (ii) a change rate of the at least one of the received signals, (iii) a noise level of the at least one of the received signals and (iv) a plant loss condition, wherein the plant loss condition is associated with at least one of a void crop plant, pest damage, weed damage, field operation damage, and drought.

The agricultural crop may be a perennial crop such as sugarcane and the agricultural work machine may be a sugarcane harvester.

The location of the agricultural work machine may be determined during a harvesting operation.

The processing characteristic from the processing sensor may correspond to a sensed characteristic (e.g., pressure or force) associated with at least one of base cutter pressure, chopper pressure, and elevator speed.

The method may comprise a yield sensor disposed within or near a stream of processed crop of the agricultural work machine, the yield sensor sensing a characteristic corresponding to a mass or a volume of the processed crop.

The method may further comprise conditioning the received signals by applying at least one of a filter, delay, scaling, offset and bias removal.

The method may further comprise receiving a signal from at least one of a satellite navigation receiver or a location-determining receiver, each receiver producing the time, position, and velocity of the agricultural work machine.

The step of determining the presence of a void crop plant may further comprise analyzing whether the received signals indicate a void crop characteristic and assigning a confidence factor to each of the received signals with a void crop characteristic.

The void crop characteristic indicates the presence of a void crop plant or a developmentally delayed plant.

The step of generating a void crop map may be performed with a processor, the processor located either onboard the agricultural work machine or offboard the agricultural work machine and the onboard or offboard generation of the void crop map occurring as the agricultural work machine moves through the field or subsequent to the agricultural work machine moving through field.

The method may further comprise the step of generating, using the void crop map, at least one of a planting field operation prescription, harvest field operation prescription, and a crop care field operation prescription.

The planting field operation prescription may include replanting a void crop.

The harvest field operation prescription may include adjusting at least one of a speed of a harvester, cleaning settings or engine management.

The crop care field operation prescription may include adjusting the operation of a sprayer, cultivator or fertilizer.

A system for mapping the location of void crops of a crop in a field, the system comprising: an agricultural working machine; at least two sensors associated with agricultural working machine; and a data processor configured to determine the presence of a void crop plant using the received signals from the at least two sensors and generate a void crop map, the crop map showing the relative locations of void crop plants within the crop field.

The at least two sensors may be configured to sense parameters relating to at least one of the crop in the field or the agricultural work machine.

A method for mapping an agricultural crop in a field, the method comprising: receiving signals from a yield sensor, which senses a yield characteristic of a process crop, and a processing sensor, which senses a processing characteristic of the processed crop, associated with an agricultural work machine; determining a crop yield using the received signals; and generating a crop yield map using a time and georeferenced location of the crop yield associated with the location of the agricultural work machine during a field operation.

The method may further comprise classifying the received signals using at least one of a fuzzy logic, machine learning, clustering or statistical analysis classification system.

The method may include the step of determining and assigning a confidence factor to each of the received signals associated with the yield and processing sensors for a sampling interval.

The step of determining a confidence factor may further comprise determining an aggregate confidence indicator for the crop yield within the map based on the confidence factors related to an estimated accurateness of the received signal.

The estimated accurateness of the received signal may be based on at least one of (i) a range of the at least one of the received signals, (ii) a change rate of the at least one of the received signals, (iii) a noise level of the at least one of the received signals and (iv) a plant loss condition, wherein the plant loss condition is associated with at least one of a planting skip, pest damage, weed damage, field operation damage, and drought.

The method may also include the step of determining the crop yield for the sampling interval using the received signals and at least one of the associated confidence factors.

The agricultural crop may be a perennial crop such as sugarcane and the agricultural work machine may be a sugarcane harvester.

The location of the harvester may be determined during a harvesting operation.

The processing characteristic from the processing sensor may correspond to a pressure or force associated with at least one of base cutter pressure, chopper pressure, and elevator speed.

The step of receiving signals may further comprise receiving a yield characteristic from a yield sensor coupled to an elevator on the harvester, the yield characteristic corresponding to a mass or a volume of the harvested material.

The method may further comprise conditioning the received signals by applying at least one of a filter, delay, scaling, offset and bias removal.

The step of receiving signals may further comprise receiving a signal from at least one of a satellite navigation receiver or a location-determining receiver that produces the time, position, and velocity of the agricultural work machine.

The step of determining the crop yield may further comprise analyzing the signals for yield characteristics and weighing the signals with a yield characteristic and their assigned confidence indicator.

The step of generating a crop yield map may be performed either onboard the agricultural work machine or offboard the agricultural work machine, the onboard or offboard generation of the crop yield map occurring as the agricultural work machine moves through the field or subsequent to the agricultural work machine moving through field.

The method may further comprise the step of generating, using the crop yield map, at least one of a planting field operation prescription, harvest field operation prescription, and a crop care field operation prescription.

The planting field operation prescription may include adjusting a planting rate.

The harvest field operation prescription may include adjusting at least one of the speed of a harvester, cleaning settings or engine management.

The crop care field operation prescription may include adjusting the operation of a sprayer, cultivator or fertilizer. Other features and aspects will become apparent by consideration of the detailed description and accompanying drawings.

### DETAILED DESCRIPTION OF THE DRAWINGS

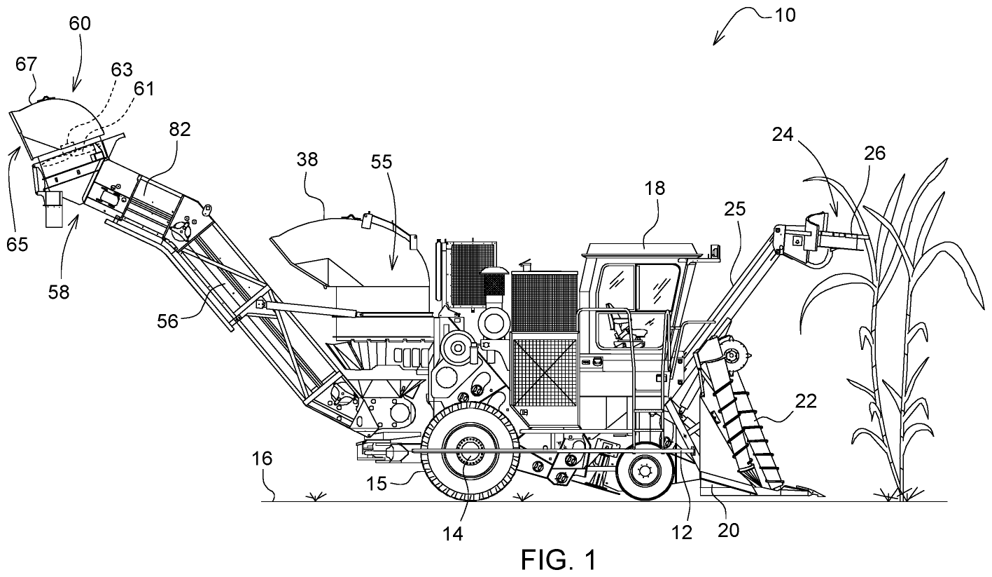

FIG. 1 is a side view of an agricultural working machine in the form of a sugarcane harvester;

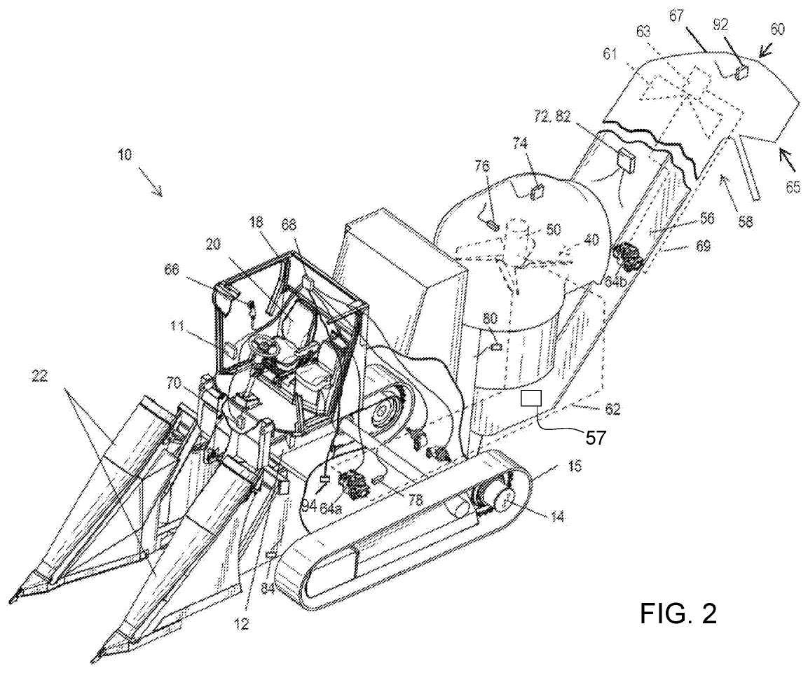

FIG. 2 is a perspective view of the sugarcane harvester shown in FIG. 1;

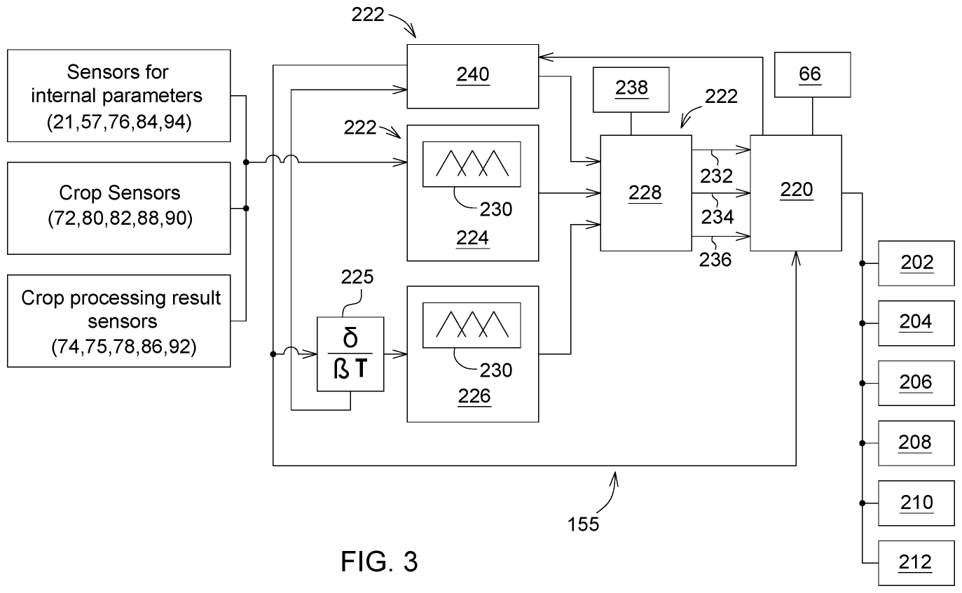

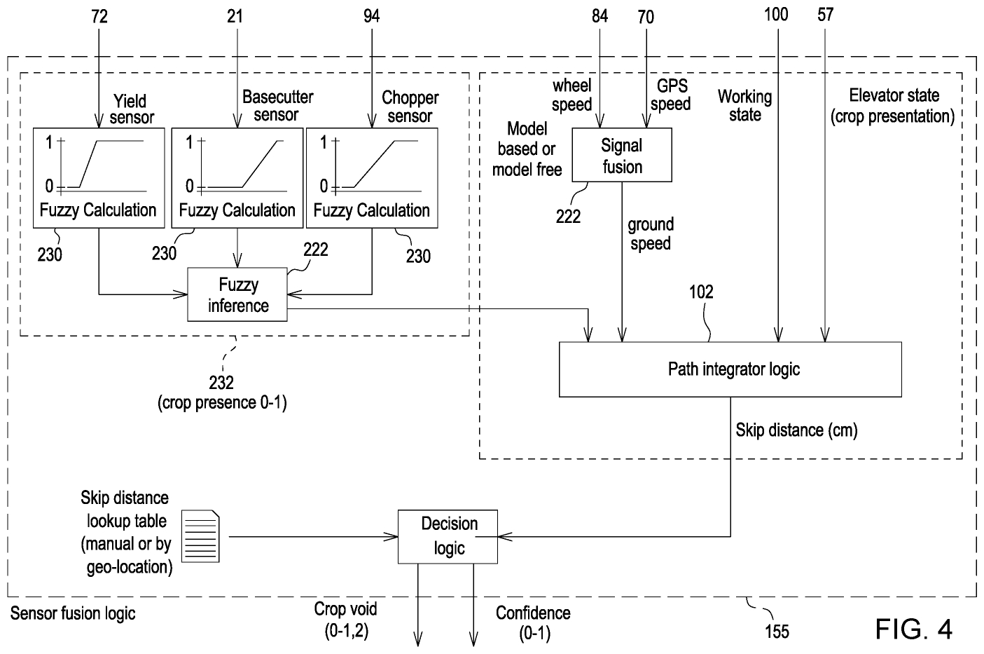

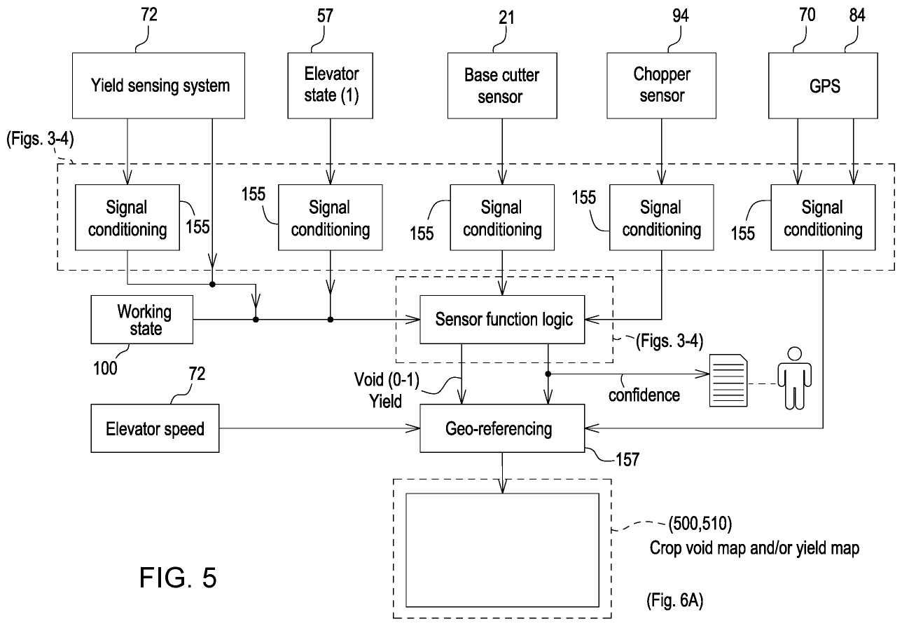

FIG. 3 is a schematic diagram of one example of sensor fusion logic of the sugarcane harvester control system;

FIG. 4 is a schematic diagram of another example of sensor fusion logic of the sugarcane harvester control system;

FIG. 5 is a schematic diagram of a sugarcane harvester control system;

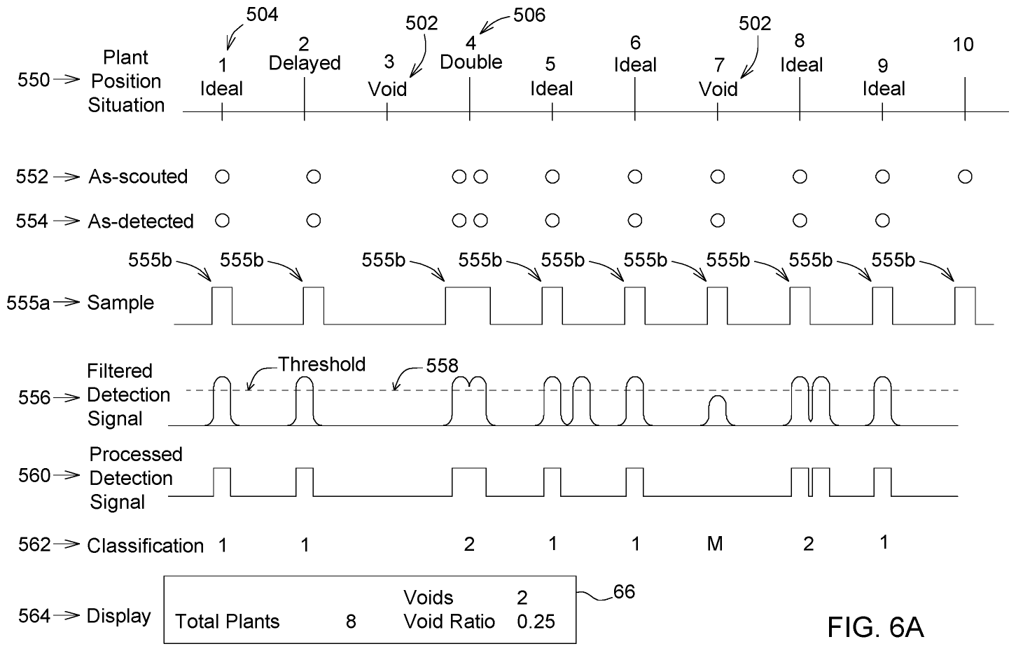

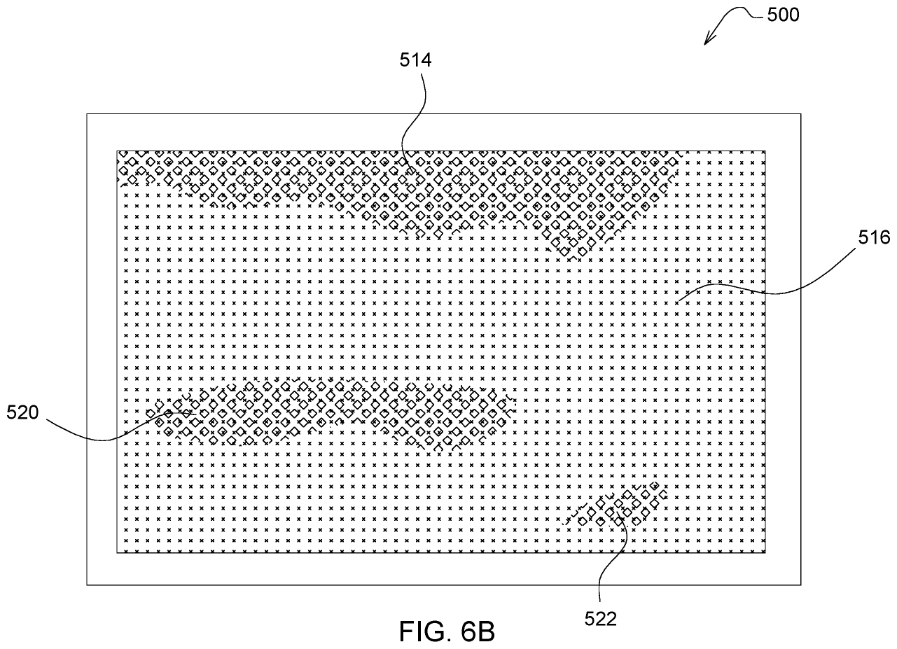

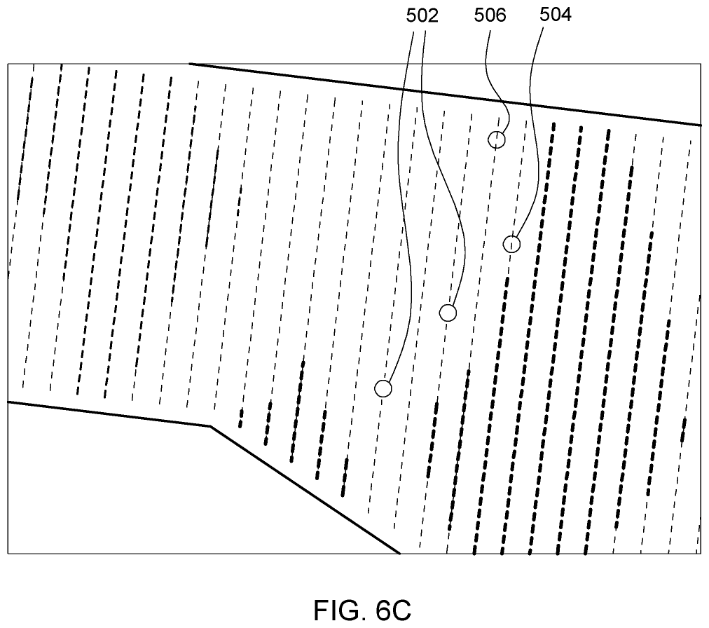

FIG. 6A is a schematic representation of the operation of a void crop detection and yield sensing system of a sugarcane harvester;

FIG. 6B is an exemplary schematic representation of crop yield projected onto the map of FIG. 5;

FIG. 6C is an exemplary schematic representation of void crop plants projected on the map of FIG. 5;

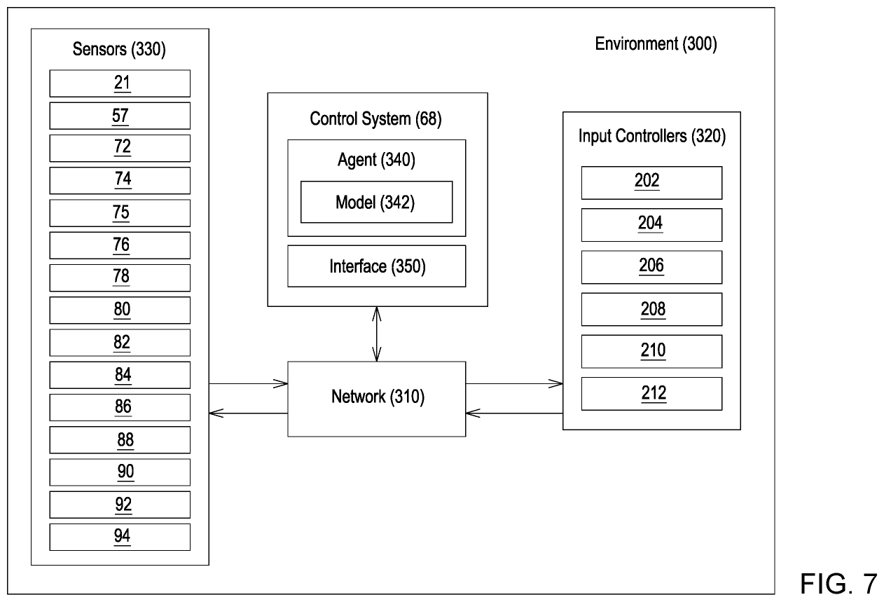

FIG. 7 is a high-level illustration of a network environment according to one example embodiment of a sugarcane harvester;

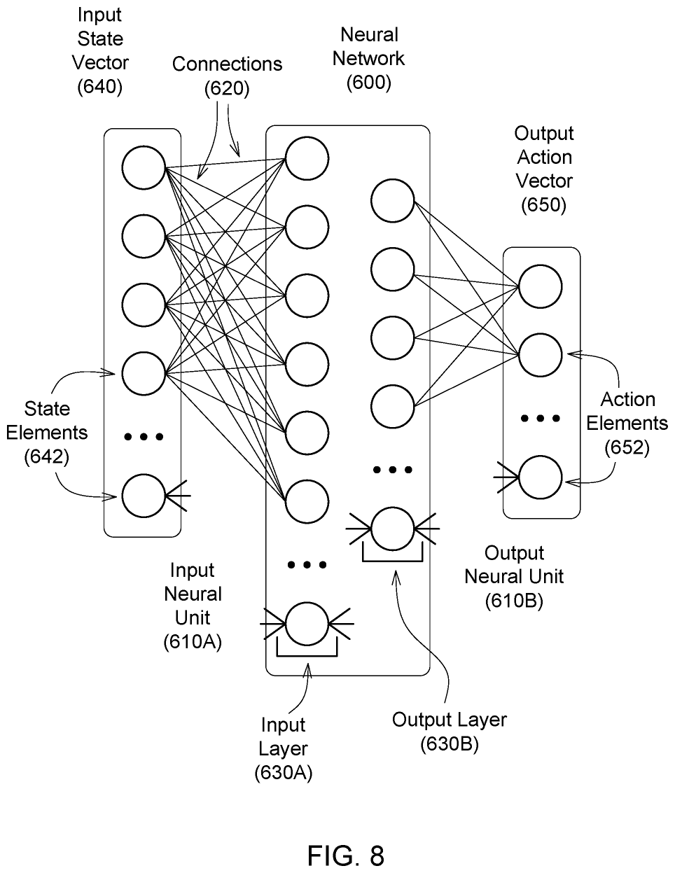

FIG. 8 is an illustration of an artificial neural network of the model according to one example embodiment of a sugarcane harvester;

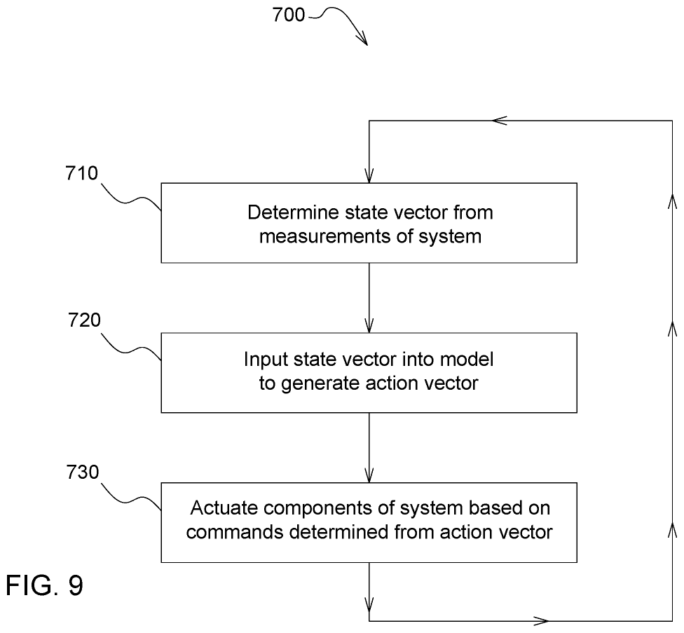

FIG. 9 is a flow diagram illustrating a method for generating actions that improve harvester performance using an agent executing a model including an artificial neural network; and

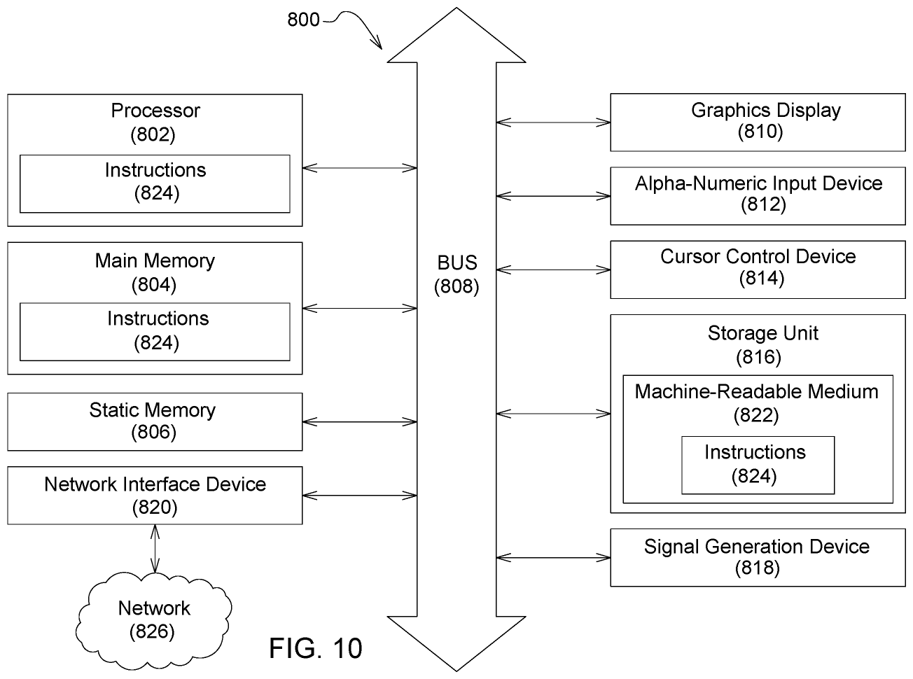

FIG. 10 is a block diagram illustrating components of an example sugarcane harvester for reading and executing instructions from a machine-readable medium.

### DETAILED DESCRIPTION

FIGS. 1-2 illustrates a harvester 10, such as a sugarcane chopper harvester, which includes a prime mover (not shown), such as an internal combustion engine, for providing motive power and a throttle 11 for controlling a speed of the prime mover and thus a ground speed of the harvester 10. Further, harvester 10 includes a frame 12 supported on wheels 14 having continuous tracks 15, tires, or other traction devices that engage a field 16. The tracks 15 interact directly with the field 16 and are responsible for harvester 10 movement and tractive effort, although in other constructions the harvester 10 is provided only with wheels (rather than tracks as illustrated). An operator's cab 18 is mounted on the frame 12 and contains a seat 19 for an operator. A pair of crop lifters 22 having side by side augers or scrolls is mounted to the front of the frame 12, which operate on opposite sides of a row of crop to be harvested. The crop lifters 22 cooperate with upper and lower knockdown rollers and a base cutter 20 (generally shown in FIG. 1) including counter-rotating discs which cut off the stalks of crop close to the field 16 after being knocked down by the rollers. The crop lifters 22 are configured to lift the sugarcane for feeding into a feed section (not shown). Additionally, the harvester 10 may be equipped with a topper 24 extending from the frame 12 on a boom 25. The topper 24 has a blade or blades 26 for cutting the tops off crop and allowing for easier processing of the remaining crop by the harvester 10.

As generally seen in FIG. 1, the chopper 28 is configured to receive a mat of severed sugarcane from the feed section (not shown). The chopper 28 cuts the crop and the separator 55 receives the cut crop from the chopper 28 and generally separates the cut crop by way of a crop cleaner, which will be described in greater detail below. The crop cleaner may include any suitable mechanism for cleaning the cut crop, such as a fan (as in the illustrated construction that will be described below), a source of compressed air, a rake, a shaker, or any other mechanism that discriminates various types of crop parts by weight, size, shape, etc. to separate extraneous plant matter from billets. The separator 55 may include any combination of one or more of a cleaning chamber, a cleaning chamber housing, a crop cleaner such as a fan 40, a fan enclosure, a motor 50 driving the fan 40, a hood 38 having an opening 54, and a centrifugal blower wheel 46.

The separator 55 is coupled to the frame 12 and located downstream of the crop lifters 22 for receiving cut crop from the chopper 28. The chopper 28 includes counter-rotating drum cutters 30 with overlapping blades for cutting the stalks of crop, such as cane C, into billets B, which are pieces of the stalk. In other constructions, the chopper 28 may include any suitable blade or blades for cutting the stalks of crop. The crop also includes dirt, leaves, roots, and other plant matter, which will be collectively referred to herein as extraneous plant matter, which are also cut in the chopper 28 along with the cane C. The chopper 28 directs a stream of the cut crop (cut stalks, or billets B, and cut extraneous plant matter) to the cleaning chamber, which is generally defined by the cleaning chamber housing, the fan enclosure, and/or the hood 38, all of which are coupled to the frame 12 and located just downstream of the chopper 28 for receiving cut crop from the chopper 28. The fan enclosure is coupled to the cleaning chamber housing and may include deflector vanes 31.

The hood 38 is coupled to the fan enclosure and has a domed shape, or other suitable shape, and includes an opening 54 angled out from the harvester 10 and facing slightly down onto the field 16. In some constructions, the opening 54 may be generally perpendicular to the drive shaft. The hood 38 directs cut crop through the opening 54 to the outside of the harvester 10, e.g., for discharging a portion of cut crop removed from the stream of cut crop back onto the field 16 (as will be described in greater detail below).

Mounted for rotation in the cleaning chamber is the fan 40. For example, the fan 40 may be in the form of an extractor fan having axial flow fan blades (not shown) radiating out from, and joined to, a hub (not shown). In the illustrated construction, the fan 40 (or other crop cleaner) is configured to draw air and extraneous plant matter from the cleaning chamber. In other constructions, the fan 40 (or other crop cleaner) may be configured to blow rather than extract, i.e., to blow or push the air through the cleaning chamber to clean the crop. The fan 40 may include other types of fans with other types of blades, such as a centrifugal fan, amongst others. The centrifugal blower wheel may be mounted for rotation with the fan 40 radially inwardly of the deflector vanes. For example, a plurality of generally right-angular blower blades may be fixed to the underside of the centrifugal blower wheel radiating out therefrom.

The motor 50, such as a hydraulic motor, includes a drive shaft operatively coupled to drive the fan 40. For example, the drive shaft may be keyed to the hub or operatively coupled in other suitable ways to drive the fan 40. The motor 50 may also be operatively coupled to drive the centrifugal blower wheel in a similar manner. In other constructions, the motor 50 may be electric, pneumatic, or may include any other suitable type of motor, an engine, or a prime mover to drive the fan 40 and/or the centrifugal blower wheel 46.

Referring again to FIGS. 1-2, an elevator 56 is coupled to the frame 12 for receiving cleaned crop from the separator 55. The elevator 56 terminates at a discharge opening 58 (or outlet) elevated to a height suitable for discharging cleaned crop into a collection receptacle of a vehicle (not shown), such as a truck, wagon, or the like following alongside the harvester 10. A secondary cleaner 60 may be located adjacent the discharge opening 58 for cleaning the crop a second time before being discharged to the vehicle. For example, the secondary cleaner 60 may include a fan, compressed air, a rake, a shaker, or other suitable device for cleaning the crop and ejecting the cleaned crop out a secondary cleaner outlet 65.

Briefly, the billets B are generally separated as described in U.S. Patent Publication No. 20190037770, jointly owned with the present application, the entire contents of which are incorporated herein by reference. The billets are separated from the extraneous plant matter in a cleaning chamber as the fan 40 draws the generally lighter extraneous plant matter into the hood 38 and out the opening 54. All the cut crop directed through the opening 54, which is ejected back onto the field 16, is referred to herein as residue. Residue typically includes primarily the extraneous plant matter (which has generally been cut) and may include some billets. The cleaning chamber housing directs the cleaned crop to the elevator 56. The cleaned crop typically includes primarily billets, although some extraneous plant matter may still be present in the cleaned crop. Thus, some extraneous plant matter may be discharged with the billets B from the discharge opening 58. Extraneous plant matter discharged from the discharge opening 58 to the vehicle is referred to herein as trash.

### Exemplary System and Inputs

A first hydraulic circuit 62 for powering the motor 50 is operatively coupled thereto and a second hydraulic circuit 69 for powering the motor 63 is operatively coupled thereto. In other constructions, the circuits 62, 69 may be electric, pneumatic, may comprise mechanical linkages, etc. In other constructions, the motors 50, 63 may be powered by the same hydraulic circuit including controllable valves. A detailed description of one example of a hydraulic circuit for a harvester fan can be found in U.S. Patent Publication No. 2015/0342118, jointly owned with the present application, the entire contents of which are incorporated herein by reference. For example, the hydraulic circuits 62, 69 are closed-loop hydraulic circuits, which are powered by a pump 64a, 64b, respectively. Each pump 64a, 64b may be driven by the prime mover (not shown) of the harvester 10 or other power source.

With reference to FIG. 2, the harvester 10 also includes an operator interface 66 (e.g., a display, buttons, a touch screen, a graphical user interface, any combination thereof, or the like) with which a user can input settings, preferences, commands, etc. to control the harvester 10. In another example, operator interface 66 may also include a working state monitor 100, such as a harvest activity or machine activity monitor. Where working state monitor 100 is a harvest activity monitor, the monitor—can accumulate and display information relating to at least: harvesting time and distance traveled; headland turnaround time and distance traveled; time and distance traveled on the road; harvester idle time while waiting for transport or other; total time that engine is running and distance traveled. Such information, in combination or in part, can help the operator identify areas of inefficiencies and take corrective action to reduce among other things logistics cost.

The operator interface 66 (including the working state monitor 100) is operatively coupled with a control unit 68, such as a microprocessor-based electronic control unit or the like, for receiving signals from the operator interface 66 and from several sensors and for sending signals to control various components of the harvester 10 (examples of which will be described in greater detail below). Signals, as used herein, may include electronic signals (e.g., by circuit or wire), wireless signals (e.g., by satellite, internet, mobile telecommunications technology, a frequency, a wavelength, Bluetooth®), or the like. The control unit 68 may include a memory and programming, such as algorithms. The harvester 10 also includes a global positioning system 70 operatively connected to send signals to the control unit 68. The aforementioned sensors may include a yield monitoring sensor 72, a billet loss sensor 74, a crop processing sensor 75, a primary cleaner sensor 76, a secondary cleaner sensor 92, a load sensor 78, a moisture sensor 80, temperature sensor 88, a relative humidity sensor 86, a trash sensor 82, and a ground speed sensor 84. The control unit 68 is programmed to include a monitoring system that monitors harvester functions, switch states, ground speed, and system pressures as will be described in greater detail below. Exemplary control unit inputs:

Elevator sensor 57 for detecting at least a pressure in pounds per square inch on the elevator 56. In another example, the sensor detects a speed of the elevator 56. In yet another example, the elevator sensor 57 detects a belt deflection of elevator 56, the amount of belt deflection determined using a distance measurement detected by a camera or strain gauges associated with the belt of elevator 56.

Chopper sensor 94 (not shown) for detecting at least a pressure or force in pounds per square inch on a chopper 28 and/or the operation of an associated chopper actuator 208. In another example, the sensor detects a speed of the counter-rotating drum cutters (not shown) or other type of chopper. In yet another example, chopper 28 is powered by an electric drive and thus chopper sensor 94 may be configured to sensor motor current of the electric drive. The sensed motor current would serve as a proxy for torque or load. Other torque or load sensing techniques may also be utilized to sense parameters of chopper 28.

Base cutter sensor 21 (not shown) for detecting at least a pressure in pounds per square inch on a base cutter 20 and/or the operation of an associated base cutter actuator 202. In another example, the sensor detects speed of the counter-rotating discs, or other cutting device, of the base cutter 20. In yet another example, base cutter 20 is powered by an electric drive and thus base cutter sensor 21 may be configured to sensor motor current of the electric drive. The sensed motor current would serve as a proxy for torque or load. Other torque or load sensing techniques may also be utilized to sense parameters of base cutter 20.

Yield sensor 72 is coupled to the elevator 56 and sends at least a crop yield signal to the control unit 68 corresponding to an amount (e.g., a mass, a volume or pressure) of crop being discharged from the discharge opening 58 or on the floor of the elevator 56. In one example, the yield sensor 72 is a vision or camera-based yield sensing system. In yet another example, the yield sensor 72 is a vision or camera-based yield sensing system that is not solely associated with the elevator 56. In this example, the yield sensing system is a forward-looking camera system that estimates yield using mean density or reflection intensity determined by image recognition or radar sensing technologies.

Billet loss sensor 74 may include one or more accelerometers and/or any sensor that measures displacement or strain, or the like. The billet loss sensor 74 is associated with the separator 55, or more specifically coupled to the separator 55. For example, the billet loss sensor 74 may be associated with, or coupled to, a cleaning chamber housing, a fan enclosure, the hood 38, the fan 40, the fan blades, the hub, a centrifugal blower wheel, a right angular blower blades, the drive shaft, etc., or any of the associated structures. In the illustrated construction, the billet loss sensor 74 is coupled to the hood 38 (FIG. 1); however, it can be attached to a sounding plate in the exhaust of the fan 40 or other suitable locations within or proximate to the stream of crop flow through the harvester 10.

The billet loss sensor 74 is configured for sending a signal to the control unit 68 corresponding to each billet passing through the separator 55 and, more specifically, out the opening 54. For example, the billet loss sensor 74 includes an accelerometer that detects the impact of a billet hitting the fan 40 and/or a housing part, such as the hood 38. In other constructions, the billet loss sensor 74 may include a piezoelectric sensor or employ another suitable sensing technology. The billet loss sensor 74 sends a signal to the control unit 68 each time a billet is detected. The control unit 68 records and counts the billets and may associate the billet signal data with a time, a location (e.g., from the GPS 70), etc.

Crop Processing Sensor 75 (not shown) is a crop processing result sensor for detecting the quality of or damage to the crop—such as damage to billets—as the crop passes through the harvester such as, in one example, along elevator 56. In another example, the crop processing sensor detects ratoon damage, including the quality of the cut (e.g., cut loss), stubble height, and lifted off/in ground. Sensor 75 may include vision technology (e.g., a camera) disposed proximate the elevator 56 and/or the discharge opening 58 and sending a signal to the control unit 68 corresponding to total damaged billets discharged from the discharge opening 58 and/or a number of damaged billets being discharged from the discharge opening 58. The sensor 75 may quantify the number of damaged billets as an absolute amount or as a percentage of the total passing through the discharge opening 58.

Primary cleaner sensor 76 may be associated with, or coupled to the separator 55. In one example, the separator 55 includes a fan 40, and, accordingly, the sensor 76 may be coupled to, for example, the blades, the motor 50, the drive shaft, etc., or to any suitable location adjacent the fan 40. For example, the primary cleaner sensor 76 may include magnets, proximity sensors, Hall Effect sensors, etc., to count revolutions of the blades, the drive shaft, or other part of the fan 40 and send signals to the control unit 68 corresponding to, and used to determine, the fan speed. In another example, the primary cleaner sensor 76 includes pressure or torque sensors associated with the motor 50, wherein the sensors measure speed and pressure to calculate the total power of the fan 40. The primary cleaner sensor 76 may also include other suitable sensing technologies for determining operation characteristics of the cleaner, including where the cleaner is a separator 55 having a fan speed.

Secondary cleaner sensor 92 may be associated with, or coupled to, the secondary cleaner 60. The secondary cleaner 60 may be, for example, a fan within a secondary cleaner hood 67 and the sensor 92 may be coupled to, for example, the blades 61, the motor 63, the drive shaft, etc., or to any suitable location adjacent the fan. For example, the secondary cleaner sensor 92 may include magnets, proximity sensors, Hall Effect sensors, etc., to count revolutions of the blades, the drive shaft, or other part of the fan and send signals to the control unit 68 corresponding to, and used to determine, the fan speed. In another example, the secondary cleaner sensor 92 includes pressure or torque sensors associated with the motor 63, wherein the sensors measure speed and pressure to calculate the total power of the fan. The secondary cleaner sensor 92 may also include other suitable sensing technologies for determining fan speed.

Moisture sensor 80 is positioned to detect moisture of the crop. Crop having more moisture is heavier and harder to draw through the separator 55 and therefore requires more power from the fan 40. The moisture sensor 80 may include a near infrared, capacitive, radar or microwave type sensors or other suitable moisture-detecting technologies and may work in cooperation with a humidity sensor 86 and/or a temperature to indicate conditions of the cut crop material prior to its being processed (i.e. threshed, cleaned, or separated) in the harvester 10. For example, the moisture sensor 80 is disposed on the harvester 10 and may be positioned in the chopper 28, in the separator 55, and/or in the elevator 56 and, more specifically, in any of the components of the harvester 10 associated therewith as described above. In the illustrated construction, the moisture sensor 80 is disposed in the separator 55 and, more specifically, in the hood 38. The moisture sensor 80 sends a signal to the control unit 68 corresponding to a level of moisture in the crop.

Trash sensor 82 may include vision technology (e.g., a camera) disposed proximate the elevator 56 and/or the discharge opening 58 and sending a signal to the control unit 68 corresponding to total yield discharged from the discharge opening 58 and/or an amount of trash being discharged from the discharge opening 58. The trash sensor 82 may quantify the amount of trash as an absolute amount or as a percentage of total mass or as a percentage of total volume through the discharge opening 58. The trash sensor 82 may be disposed in the elevator 56 or other suitable locations within or proximate to the discharge stream of crop from at least one of the primary cleaning fan 40 or secondary cleaning fan. The trash sensor 82 may include other sensing technologies for determining the amount of trash being discharged from the discharge opening 58. In one example, the amount of trash quantified by trash sensor 82 is representative of leaf impurities as an absolute amount or as a percentage of total volume or total mass within the material on elevator 56 and/or mineral impurities that may impact the subsequent milling process.

Ground speed sensor 84 may be associated with ground speed actuator 212 and may include a speedometer, a radar sensor, a velocimeter such as a laser surface velocimeter, a wheel sensor, or any other suitable technology for sensing vehicle speed, is configured to send a ground speed signal to the control unit 68 corresponding to the speed of the harvester 10 with respect to the field 16. It is recognized by one of skill in the art that the ground speed sensed by ground speed sensor 84 is different than the ground speed sensed by GPS 70. However, a ground speed signal could be approximated by the GPS 70 after accounting for measurements issues, wheel slip, etc.

Load sensor 78 senses a load on the separator 55 and/or the operation of an associated separator actuator 210. For example, the load sensor 78 may measure a load on the motor 50 and may include any suitable type of sensor for the type of motor employed, e.g., electric, pneumatic, hydraulic, etc. In some constructions, the load sensor 78 may include a strain gage(s) for measuring a torque load or an amp meter for measuring an electrical load. The load on the motor 50 may also be measured indirectly, such as by measuring a load on the fan 40 and/or a centrifugal blower wheel. In some constructions, such as the illustrated construction employing a motor 50, the load sensor 78 may include a pressure transducer, or other pressure sensing technology, in communication with the hydraulic circuit 62 for measuring pressure within the circuit 62. For example, the load sensor 78 may be coupled to the motor 50 or to the pumps 64a, 64b or anywhere along the circuit 62 to measure the associated pressure in the circuit 62. The load sensor 78 sends load signals to the control unit 68. The load sensor 78 measures a baseline load, or lower load limit, when the harvester 10 is running and no crop is being cut, and a current (or present) load when crop is being cut.

Lens Cleanliness Indicator 90 may include a sensor for determining how dirty the camera is in a camera-based yield sensing system and how much, if any, cleaning is required. In another example, the lens cleanliness indicator 90 senses how the dirty the camera using a visual flow reading.

Signals from the sensors include information on environmental variables such as temperature, relative air humidity, and information on variables controlled by the onboard control unit 68 which may include vehicle speed signals from the ground speed sensor 84, chopper sensor 94, elevator speed sensor 57, base cutter sensor 21, and primary cleaner sensor 76, respectively. Additional signals originate from billet loss sensor 74, load sensor 78, trash sensor 82, lens cleanliness indicator 90, secondary cleaner sensor 92 and various other sensor devices on the harvester such as a yield monitoring sensor 72 and crop moisture sensor 80.

A communications circuit directs signals from the mentioned sensors and an engine speed monitor, flow monitoring sensor, and other microcontrollers on the harvester to the control arrangement 155. Signals from the operator interface 66 are also directed to the control arrangement 155. The control arrangement 155 is connected to actuators 202, 204, 206, 208, 210, 212 for controlling adjustable elements on the harvester 10.

### Exemplary Sugarcane Harvester Inference

Generally, a method and system is provided which substitutes direct measurements (e.g., one or more received sensor signals such as a void crop plant sensor or yield sensor) with an inferred signal generated from indirect measurements (e.g., one or more received signals such as pressures and speeds). In another example, a method and system is provided which corrects direct measurements (e.g., one or more received sensor signals such as a void crop plant sensor or yield sensor) with an inferred signal generated from indirect measurements (e.g., one or more received signals such as pressures and speeds). This correction provides confidence values for direct measurement values as well to identify and compensate for direct measurement sensor inaccuracies or faults. The method and system classifies the one or more received sensor signals into many classes, e.g., void crop plant, crop yield, etc. The system could utilize any of fuzzy logic, machine learning, clustering, or statistical analysis to classify a received sensor signal. The type of classification system used depends in part upon the physical construction of the harvester, the type of actuators and sensors used, how fast each actuator responds to changes, position of the actuators and sensors with respect to the flow of material through the machine and any resulting delays.

Referring now to FIGS. 3-5, multiple examples of inference and classifications systems are provided. For example, in FIG. 3 the actuators controlled by the control arrangement 155 comprise a base cutter actuator 202 configured to control the speed of the base cutter 20, a lifter actuator 204 configured to control the rotational speed of the crop lifters 22, a topper actuator 206 configured to control the height and/or speed of topper 24, a chopper actuator 208 configured to control the speed of chopper 28, a separator actuator 210 configured to control the operation of separator 55, and a ground speed actuator 212 configured to control the ground speed of the harvester 10. In one example, adjustment of the operation of the separator 55 by control arrangement 155 may include adjustments to speed, duration, clearances, openings, airflow, deflection, etc. in any combination to one or more of a cleaning chamber, a cleaning chamber housing, a crop cleaner such as a fan 40, a fan enclosure, a motor 50 driving the fan 40, a hood 38 having an opening 54, and a centrifugal blower wheel.

The control arrangement 155 comprises a controller circuit 220 that receives signals from at least: ground speed sensor 84, base cutter sensor 21, primary cleaner sensor 76, chopper sensor 94, elevator sensor 57, load sensor 78 (which represent internal parameters of the harvesting machine, e.g., separator), yield monitoring sensor 72, (which may include a mass flow sensor), a moisture sensor 80, a relative humidity sensor 86, a temperature sensor 88, a lens cleanliness indicator 90 and crop processing result sensors (which includes the billet loss sensor 74, crop processing sensor 75, trash sensor 82 and secondary cleaner sensor 92).

The controller circuit 220 comprises one or more electronic control units (ECUs) each of which further comprise a digital microprocessor coupled to a digital memory circuit. The digital memory circuit contains instructions that configure the ECU to perform the functions described herein. There may be a single ECU that provides all the functions of the controller circuit 220 described herein. Alternatively, there may be two or more ECU's connected to each other using one or more communications circuits. Each of these communications circuits may comprise one or more of a data bus, CAN bus, LAN, WAN or other communications arrangement. In an arrangement of two or more ECUs, each of the functions described herein may be allocated to an individual ECU of the arrangement. These individual ECU's are configured to communicate the results of their allocated functions to other ECUs of the arrangement.

In one example of a classification system, as shown in FIGS. 3-4, a fuzzy logic circuit 222 is provided for classifying signals. In FIG. 3, fuzzy logic circuit 222 comprises a first parameter range classifier circuit 224, a second parameter range classifier circuit 226 and an operating state evaluation circuit 228. The fuzzy logic circuit 222 comprises one or more electronic control units (ECUs) each of which further comprise a digital microprocessor coupled to a digital memory circuit. The digital memory circuit contains instructions that configure the ECU to perform the functions described herein.

There may be a single ECU that provides all the functions of the fuzzy logic circuit 222 described herein. Alternatively, there may be two or more ECU's connected to each other using one or more communications circuits. Each of these communications circuits may comprise one or more of a data bus, CAN bus, LAN, WAN or other communications arrangement. In an arrangement of two or more ECUs, each of the functions described herein may be allocated to an individual ECU of the arrangement. These individual ECU's are configured to communicate the results of their allocated functions to other ECUs of the arrangement.

A first parameter range classifier circuit 224 receives signals from the ground speed sensor 84, base cutter sensor 21, billet loss sensor 74, chopper sensor 94, elevator sensor 57, primary cleaner sensor 76, load sensor 78 (which represent internal parameters of the harvesting machine, e.g., separator), yield monitoring sensor 72 (which may include a mass flow sensor), the moisture sensor 80, the relative humidity sensor 86, the temperature sensor 88, lens cleanliness indicator 90, and crop processing result sensors (which includes the billet loss sensor 74, the crop processing sensor 75, trash sensor 82 and secondary cleaner sensor 92).

The system for detecting the operating state of the harvester 10 further comprises a differentiating circuit 225 which is coupled to each of the sensors 84, 21, 76, 94, 57, 76, 74, 75, 78, 72, 80, 86, 88, 82, and 90 to receive a corresponding signal therefrom. The differentiating circuit 225 is configured to calculate a time rate of change for each of the signals it receives from sensors 84, 21, 76, 94, 57, 76, 74, 75, 78, 72, 80, 86, 88, 82, and 90. The differentiating circuit 225 is further configured to transmit a corresponding continuous signal for each of the sensors indicating the time rate of change for that sensor 84, 21, 76, 94, 57, 76, 74, 75, 78, 72, 80, 86, 88, 82, and 90. The differentiating circuit 225 is coupled to the second parameter range classifier circuit 226 to provide the continuous time rate of change signals to the second parameter range classifier circuit 226.

A second parameter range classifier circuit 226 receives the time rate of change signals for each sensor 84, 21, 76, 94, 57, 76, 74, 75, 78, 72, 80, 86, 88, 82, and 90 from the differentiating circuit 225, which in turn received signals from the ground speed sensor 84, base cutter sensor 21, billet loss sensor 74, chopper sensor 94, elevator sensor 57, primary cleaner sensor 76, load sensor 78 (which represent internal parameters of the harvesting machine, e.g., separator), yield monitoring sensor 72 (which may include a mass flow sensor), the moisture sensor 80, the relative humidity sensor 86, the temperature sensor 88, and crop processing result sensors (which includes the billet loss sensor 74, the crop processing sensor 75, trash sensor 82 and secondary cleaner sensor 92).

Each of the first parameter range classifier circuit 224 and the second parameter range classifier circuit 226 comprises several fuzzy classifier circuits 230. Each of the sensors 84, 21, 76, 94, 57, 76, 74, 75, 78, 72, 80, 86, 88, and 82 is coupled to a corresponding fuzzy classifier circuit 230 of the first parameter range classifier circuit 224 to transmit its sensor signal thereto. Each of the sensors 84, 21, 76, 94, 57, 76, 74, 75, 78, 72, 80, 86, 88, 82, and 90 is coupled to a corresponding fuzzy classifier circuit 230 of the second parameter range classifier circuit 226 (via the differentiating circuit 225) to transmit a time derivative of it sensor signal thereto. Each of the fuzzy classifier circuits 230 is configured to classify the sensor signal it receives into a number of classes. Each of the fuzzy classifier circuits 230 in the first parameter range classifier circuit 224 evaluates the range (fuzzy class) of its corresponding sensor signal. Each of the fuzzy classifier circuits 230 in the second parameter range classifier circuit 226 evaluates the change rate of its corresponding sensor signal.

Generally, the fuzzy classifier circuits 230 perform their classifications according to a predetermined specification that is generated in advance based on machine learning, clustering, statistical analysis, expert knowledge or another suitable system. The parameters and coefficients employed by each fuzzy classifier circuit 230 will depend upon the type of sensor to which the fuzzy classifier circuit 230 is coupled. They will also depend upon the physical construction of the harvester, the type of actuators and sensors used, how fast each sensor and actuator responds to changes commanded by the controller circuit 220, position of the actuators and sensors with respect to the flow of material through the machine and any resulting delays.

Changes to the specification during runtime are possible, if needed. The fuzzy classifier circuits 230 each provide a continuous output, the output serving as a proxy for the probability that, for example, a void crop plant has been found. Additionally, the fuzzy logic classifier circuit could be used to describe a geospatial or temporal offset between different components of the harvester 10. For example, there may be occasions when the base cutter 20 is operation but the elevator; thus, creating a geospatial or temporal offset between the readings of the base cutter sensor 21 and yield monitor 72. These outputs, the number of which corresponds to the number of input signals, are transmitted to the operating state evaluation circuit 228.

The operating state evaluation circuit 228 provides an operating state signal value 232 to controller circuit 220. The operating state signal value 232 is based upon an overall evaluation of the outputs of the first parameter range classifier circuit 224 and the second parameter range classifier circuit 226. In one example, the operating state signal value 232 is binary (0 or 1). In another example, the operating state signal value 232 is compared against a threshold (FIG. 6A) and subsequent actions are only taken depending upon whether the threshold is exceeded or not. It still another example, the operating state signal value 232—whether binary or threshold—may represent a void crop plant, a yield characteristic of the sugarcane crop being harvested or whether a steady state has been reached, i.e. whether it can be assumed that the crop processing operation (crop process) in the harvester 10 is continuous again after a parameter (like an actuator adjustment or a crop property) has been changed. When the operating signal is binary, if the operating state signal value 232 is 1, the state is considered as steady and if the operating state signal value 232 is 0, the state is not yet steady.

The fuzzy classifier circuits 230 perform the fuzzification of their respective sensor signals to provide corresponding fuzzified signals. The operating state evaluation circuit 228 is coupled to the first parameter range classifier circuit 224 and the second parameter range classifier circuit 226 to receive and combine (fuse) these fuzzified signals using an inference engine that applies a rule base, followed by a defuzzification. A suitable fuzzy logic circuit 222 is described, for example, in U.S. Pat. No. 6,315,658 B1 which is incorporated herein by reference for all that it teaches.

The operating state evaluation circuit 228 generates and outputs a confidence signal output 234 indicating an estimated accurateness of the operating state signal value 232 to controller circuit 220. In one example, the confidence signal is assessed and/or outputted as value discrete or value continuous and/or at least one of good, fair or poor. The magnitude of the confidence signal output 234 indicates the probability that the operating state signal value 232 is correct (e.g. accurate). Additionally, in one example, the operating state evaluation circuit 228 may provide a time signal 236 indicating the time interval for reaching the steady state after a crop processing parameter in the harvester 10 was altered to controller circuit 220.

The operating state evaluation circuit 228 has a trigger function input 238 for specifying the required level of confidence for indicating the presence of a void crop plant, crop yield or steady state. In one example, the trigger function input 238 is provided by manipulation of the operator interface 66 by an operator. In other examples, the trigger function input 238 is not directly input by the operator but instead is pre-set based on expert knowledge and the operator only allowed to scale up or down the trigger function input 238 with certain limits.

In one example, the operating state evaluation circuit 228 may further yet receive a reliability signal indicating a reliability of the signal of at least one of the sensors 84, 21, 76, 94, 57, 76, 74, 75, 78, 72, 80, 86, 88, 82, and 90 from a weight function evaluator 240 for prioritizing outputs of fuzzy classifier circuits 230 in an evaluation process performed by the operating state evaluation circuit 228 such that measurements from low accuracy sensors can be outweighed. In one example, the weight function evaluator 240 is pre-set using expert knowledge. In another example, the weight function evaluator 240 is system auto assigned. Specifically, the auto assignment may consider a mean distance to other measurement heuristics. The weight function evaluator 240 can thus indicate via the operator interface 66 that a sensor, like the billet loss sensor 74 (that require regular calibration) is considered as less accurate and thus its relevance in the evaluation process in the operating state evaluation circuit 228 is reduced.

The weight function evaluator 240 for prioritizing outputs of fuzzy classifier circuits 230 in the evaluation process of the operating state evaluation circuit 228 uses the signals from the respective sensors, in particular the processing result sensors (which include the billet loss sensor 74, the crop processing sensor 75, the load sensor 78, and the trash sensor 82) and/or the crop sensors (which include the yield monitoring sensor 72, the moisture sensor 80, the relative humidity sensor 86, the temperature sensor 88 and lens cleanliness indicator 90).

In another example of a classification system, the relevance of sensors with low confidence, accuracy or reliability is thus automatically reduced based upon the sensor signal and preferably a comparison with signals from other sensors as described in U.S. Pat. No. 9,826,682, which is incorporated by reference in its entirety. The weight function evaluator 240 increases the reliability of the operating state evaluation circuit 228 by automatically adjusting the impact of the individual contributions of the mentioned sensors on the overall result by analyzing the properties of incoming data. Examples include (but are not limited to) ranges, change rates, noise level and environmental conditions that give an indication concerning the assumed input reliability. This could be a simple binary accept/ignore decision or a continuous adjustment of a weighting factor to favor highly reliable information over ones that include some degree of vagueness. This way, less trustworthy or potentially faulty inputs can be weighted appropriately (reduced impact or even ignored) both temporarily and permanently. This results in better performance of the operating state evaluation circuit 228. This is useful since loss sensors tend to have a quite heavily changing performance depending on the conditions they are used in.

The controller circuit 220 thus receives the signals from the weight function evaluator 240 based on and/or relating to each of the ground speed sensor 84, base cutter sensor 21, billet loss sensor 74, chopper sensor 94, elevator sensor 57, primary cleaner sensor 76, load sensor 78 (which represent internal parameters of the harvesting machine, e.g., separator), yield monitoring sensor 72 (which may include a mass flow sensor), the moisture sensor 80, the relative humidity sensor 86, the temperature sensor 88, lens cleanliness indicator 90 and crop processing result sensors (which includes the billet loss sensor 74, the crop processing sensor 75, trash sensor 82 and secondary cleaner sensor 92), as mentioned above. The controller circuit 220 uses these signals to generate control signals for the actuators 202, 204, 206, 208, 210, 212 to achieve an optimal crop processing result. For details of the operation of the controller circuit 220, reference is made to U.S. Pat. No. 6,726,559 B2 and U.S. Pat. No. 6,863,604 B2, which are incorporated herein by reference for all that they teach. In another possible embodiment, controller circuit 220 can give proposals for actuator adjustment values to the operator via the operator interface 66, such that the operator can adjust the actuators manually.

The signals from the processing result which includes the billet loss sensor 74, the crop processing sensor 75 and trash sensor 82 are important for obtaining feedback signals to the controller circuit 220 such that the latter can provide optimal actuator adjustment signals for the actuators 202, 204, 206, 208, 210, 212. Once a crop parameter has changed, for example when soil properties on a field change, or the harvester 10 has turned in the headland of a field 16, or one or more of the actuators 202, 204, 206, 208, 210, 212 have been adjusted by the controller circuit 220, it takes some time until the crop processing operation in the harvester 10 has come to a steady state. After the steady state has been reached, the signals from the processing result sensors may again be considered (which includes the billet loss sensor 74, the crop processing sensor 75 and trash sensor 82) to be representative for the crop processing operation.

The system for detecting a void crop plant, crop yield or steady state of the harvester 10 comprising the fuzzy logic circuit 222 derive information, in whole or in part, from the signals of the ground speed sensor 84, base cutter sensor 21, billet loss sensor 74, chopper sensor 94, elevator sensor 57, primary cleaner sensor 76, load sensor 78 (which represent internal parameters of the harvesting machine, e.g., separator), yield monitoring sensor 72 (which may include a mass flow sensor), the moisture sensor 80, the relative humidity sensor 86, the temperature sensor 88, and crop processing result sensors (which includes the billet loss sensor 74, the crop processing sensor 75, trash sensor 82 and secondary cleaner sensor 92). In one example, the fuzzy logic circuit 222 submits the operating state signal value 232 to controller circuit 220 only when the signals from the processing result sensors (which includes the billet loss sensor 74, the crop processing sensor 75 and trash sensor 82) indicate a void crop plant, crop yield or steady state. The confidence signal output 234 can be considered by the controller circuit 220 for weighing the relevance of the processing result sensors (which includes the billet loss sensor 74, the crop processing sensor 75 and trash sensor 82), compared with other inputs, like those from the crop sensors (which include the load sensor 78, yield monitoring sensor 72 (which may include a mass flow sensor), moisture sensor 80, relative humidity sensor 86, temperature sensor 88 and lens cleanliness indicator 90. Additionally, the time signal 236 can be used by the controller circuit 220 for deriving crop properties (like throughput) that are used for evaluating the actuator signals.

As indicated in FIG. 3 by the optional feedback line from the controller circuit 220 to the weight function evaluator 240, the control arrangement 155 may contain a feedback mechanism that will enable the weight function evaluator 240 (or the operating state evaluation circuit 228) to learn if a decision was correct or incorrect (given the larger overview of the situation provided by e.g. operator feedback via the operator interface 66 or automated decision making in the controller circuit 220) and adjust future reliability signals accordingly.

In yet another example of classification system, a sensor fusion system is provided which does not include a confidence factor. In this approach, Kalman filters are used to create a probabilistic heuristic system and measurement model in a consecutive cycle or predication and correction for systems. One example of such a is a dead reckoning system with a position receiver and/or a camera system measuring optical flow. In this system, changes in location and pose based on a change in a mono or stereo image are integrated with a signal from a position receiver. Accordingly, this system would not have an explicit confidence factor but utilize other approaches such as: two models (system/observation) as matrices, which are then combined with the system inputs using probabilistic math algebra and/or an implicit confidence factor, expressed for example as a mean distance metric compared to other measurement heuristics.

In a further example, the sensor fusion system is provided with smart sensors which provide a confidence metric directly. Alternatively, a smart system could be created which utilizes conventional sensors to provide only measurements and signals. These measurements, signals and information would then be combined or fused at the system level to provide a confidence metric or a probabilistic heuristic.

### Exemplary Void Crop Plant Detection System

Some existing sugar cane harvesters may be equipped with void or gap sensors, each gap sensor having contact sensor arms with magnets in them and an associated magnetic field sensor on machine, to sense void crop plants or gaps. Void crop plants in rows may then be identified and mapped via a GPS receiver 70 that logs locations of the void crop plants. In one example, a void crop plants detection system is provided that avoids the use of gap sensors. In this example, existing sensors in the sugarcane harvester hardware are leveraged including: (1) a yield-related sensor 72, such as mass flow or harvested volume sensor of harvested material, (2) base cutter sensor 21, and (3) chopper sensor 94. Yield sensor 72 may have a geospatial or temporal offset associated with it and thus could be combined with base cutter sensor 21 and/or chopper sensor 94. A GPS receiver 70 is similarly provided, the signal quality being evaluated on the number of satellites received during a sampling interval, or dilution of precision, or whether the receiver is in locked in a precise positioning mode during the sampling interval, or operating in an RTK mode with a base station during the sampling interval.

In another example, a mixed fleet is provided wherein one or more harvesters have a gap sensor and one or more other harvesters do not have a gap sensor. In this example, data from a harvester with a gap sensor could be combined with data from a harvester without gap sensor to fill in void crop plant sensing and/or mapping gaps. In this example, some of the machines have no direct gap sensor data and thus produce only estimated void crop plant data. The estimated void crop plant data could then be used as trend data and aligned with the actual gap sensor data generated by those machines with a gap sensor.

Referring again to FIG. 5, the harvester 10 comprises a system for detecting void crop plant information of the harvester 10 which includes an input from yield sensor 72, a base cutter sensor 21, an elevator sensor 57, a chopper sensor 94, a GPS receiver 70, a working state monitor 100, control arrangement subsystem 155, a sensor fusion logic circuit subsystem 156 and georeferencing subsystem 157. With respect to the map 500 of field 16 in FIG. 5 and FIG. 6C, a void crop plant 502 within the field 16 representing damage to or loss of an entire plant or damage to a plant such that it will not reach an expected yield potential is shown. A void crop plant may be caused by a planting skip, pests, weeds, unintended uprooting during harvest, weather events, or damage during a field operation after planting. Many sugarcane farmers often do not map void crop plants, instead favoring fixed replanting of all plants. Where farmers are concerned with mapping void crop plants, most methods rely on manual inspection or remote sensing; each having significant disadvantages due to cost, time or technical limitations caused by, for example, residue in early season and sugarcane plant canopy in late season.

The system for detecting void crop plants relies on fusion of existing sugarcane harvester sensors (as discussed previously) to determine and map the location of void crop plants during harvest of the sugarcane or subsequent to harvest using the data collected using the collected harvest data. When the step of determining and mapping of void crop plants occurs subsequent to harvest, the determination and mapping may also be performed remotely of the harvester on a server using algorithms like those used onboard the harvester 10. In one example, the existing harvester sensors includes a standard gap sensor such as a magnetic contact sensor on a flexible arm(s) and a corresponding magnetic field sensor on the harvester. Using a standard gap sensor, gaps in rows can be detected and mapped via a position receiver that logs locations of gaps to generate a void crop plant map 500 as shown in FIG. 6C. Existing gap sensors often suffer from significant disadvantages, such as cost, exposure to harsh and abrasive environments, and imprecise measurements due to crop canopy, weeds and moisture. In cases where an existing gap sensor is present, fusion of existing sugarcane sensors can still be utilized to lessen measurement delay associated the gap sensor, correct existing measurement bias or errors of the gap sensor, and overcome physical limitations of the gap sensing system such as extreme wear of the gap sensor.

However, in another example, a standard gap sensor is not an existing sensor on the harvester 10. Instead, the existing sensors in the sugarcane harvester hardware include a yield sensor 72, which estimates a yield characteristic of a harvested material, and a processing sensor, which estimates a processing characteristic of the harvested material, associated with an agricultural work machine. In one example, the processing sensor is a sensor associated with at least one of a base cutter sensor 21 or chopper sensor 94. Optionally, it may be possible to eliminate the yield sensor 72 provided there is another source of data that can serve as a proxy for yield data. For example, yield data may be generated from predictive yield maps based on satellite, drones, plane, or other imagery. Yield data could also be generated using a physiological plant growth model that is fed with, for example, specific plant variety information, planting date, fertilizer, and crop care applications as well as weather data. Other proxies for yield data may include yield related information received from other vehicles in the field 16 either in a previous work step (e.g., previous application from the sprayer) or current work step (e.g., other harvesters harvesting adjacent passes). Yet another example would be stationary sensors such as sensor networks within a field that sense, for example, canopy cover, soil moisture and temperature sensor.

Accordingly, where a harvester is provided with a gap sensor, the gap sensor data may be combined with existing harvester sensor data from a yield sensor 72 and/or a processing senor using the previously described sensor fusion techniques to generate improved void crop plant data. The existing sensor data can be used to generated predicted void crop plant data and thus lessen measurement delay associated with gap sensor, correct existing measurement bias or errors of the gap sensor, and overcome physical limitations of the gap sensor. The existing sensors used may comprise a yield sensor 72, chopper sensor 94 or base cutter sensor 21. The sensor signals are then used as inputs to a sensor inference algorithm to generate inferred void crop plant data; which in turn can be used as trend data and aligned with the actual void crop data from the gap sensor.

However, if a gap sensor is not provided on a harvester, fusion of existing sensor data can be combined to make inferred void crop plant data (thus being converted from relative to absolute measurement). Optionally, the existing sensor data may be combined with ground truth sampling from a manual sample wherein sugarcane is viewed in person in small designated areas of the field 16 and included in a computer average. In this example, where no gap sensor is provided, existing harvester sensor data is generated by harvester sensors including but not limited to the yield sensor 72, chopper sensor 94 and base cutter sensor 21, each of which may be used in one or more combinations as inputs to a sensor inference algorithm to determine estimated void crop plant data. The sensor inference algorithm in one example is a classification algorithm utilizing one or more of a neural network or nonlinear regression.

The system can thus provide a void crop plant map as shown in map 500 of FIG. 5 and FIG. 6C in real-time or recorded and stored for use after the harvesting operation. For example, real-time mapping can be used for automation directly on the vehicle, e.g., engine management or clean settings. Conversely, the void crop plant map (or underlying void crop plant data) can be used after harvest to adjust other field operations such as crop protection, fertilizing, weeding or re-planting including variable rate application in combination with prescription mapping.

### Exemplary Crop Yield Sensing System

Referring to FIG. 5, a harvester 10 may further comprise, either individually or in combination with the void crop plant detection system, a crop yield sensing system for detecting crop yield during operation of the harvester 10. The crop yield system may include the previously mentioned control arrangement subsystem 155, sensor fusion logic circuit subsystem 156 and georeferencing subsystem 157. In this example, the system for detecting crop yield information relies on a combination of a camera-based yield sensing system and the fusion of existing sugarcane harvester sensors (as discussed previously) to determine and map crop yield(s) during harvest of the sugarcane as shown in the map 510 of FIG. 5 and FIG. 6B.

In one example, a camera-based yield sensing system on a harvester is combined with existing harvester sensors using the previously described sensor fusion techniques to generate improved yield data. The camera-based sensing system suffers from certain disadvantages including reliance on operation of the elevator 56 to properly associate sensed yield to location. Operators commonly start and stop the operation of the elevator 56 during harvest for a variety reasons, including starting and finishing a row or changing a wagon. The camera-based sensing system also measures volume based on the visible surface(s), which leads to imprecise measurements during high-flow situations where material presentation is highly variable. Other disadvantages include measurement delay and measurement bias or errors. However, these disadvantages may be lessened, and higher quality inferred yield data generated, by using the data from the existing sensors in combination with the camera-based sensing system. The existing sensors used may comprise the ground speed sensor 84, chopper sensor 94 and base cutter sensor 21. The sensor signals are then used as inputs to a sensor inference algorithm to generate inferred yield data; which in turn can be used as trend data and aligned with the actual yield data from the camera-based yield sensing system.

However, if a camera-based yield sensing system is not present on a harvester, fusion of existing sensor data can be combined to make an inferred yield (thus being converted from relative to absolute measurement). Optionally, the existing sensor data may be combined with ground truth sampling from manually cutting and weighing sugarcane billets in small designated areas of the field 16 and including the results in a computer average. In this example, where no camera-based yield sensing system is provided, existing harvester sensor data is generated from harvester sensors including but not limited to the existing ground speed sensor 84, chopper sensor 94 and base cutter sensor 21, each of which may be used in one or more combinations as inputs to a sensor inference algorithm to determine estimated yield data. The sensor inference algorithm in one example is a classification algorithm utilizing one or more of a neural network or nonlinear regression.

Alternatively, in the example of a mixed fleet wherein one or more harvesters have a camera-based yield sensing system and one or more harvesters do not have a camera-based yield sensing, data from a harvester with a camera-based yield sensing system could be combined with data from a harvester without a camera-based yield sensing system to infer crop yield data and fill in yield mapping gaps. In this example, some of the machines have no direct yield sensor data and thus produce only relative yield data. The relative yield data is used as a directional indication and aligned with the actual yield data generated by those machines with a camera-based yield sensing system.

The crop yield system, as shown in map 510 of FIGS. 5 and 6B, can provide a crop yield map in real-time or recorded and stored for use after the harvesting operation. For example, real-time mapping can be used for automation directly on the vehicle, e.g., engine management or clean settings. Conversely, the crop yield map (or underlying crop yield data) can be used after harvest for agronomic purposes to adjust other field operations such as crop protection, fertilizing, weeding or planting including variable rate application in combination with prescription mapping. When the crop yield map is generated after harvest, the crop yield determination and mapping may be performed remotely on a server using algorithms like those used onboard the harvester 10.

### Exemplary Void Crop Plant and Yield Mapping System

In another example, land data may be uploaded in one or more bulk files such as, for example, one or more binary spatial coverage files. Such a bulk file includes all the necessary information associated with an area of interest such as a sugarcane field 16. In this example, the land data is exported to a binary spatial coverage file. Such exported information may include, but is not limited to, soil type layer, customized management zone with MUSYM (map unit symbol) attribute, topographical maps including land slope, organic matter, void crop plants, crop yields or historical data such as previous crop yields or void crop plants.

Land data is typically uploaded into the control unit 68 of harvester 10, including georeferencing subsystem 157, for onboard processing. However, while this example generally discusses onboard processing, it is not intended to be limiting. For example, uploading and processing of land data could similarly be performed offboard or remote of the harvester 10 on a remote server at any point time, including before, during or after harvest. Once such data is uploaded to the georeferencing subsystem 157, Geographic Information Systems (GIS) software may name each file within the bulk file by field name. GIS software may obtain desired land data and may include all the necessary land data for the sugarcane field 16. When the land data is uploaded in bulk, the control unit 68 uses the file name to assign the field name by default. Names may be subsequently edited. If too many files are uploaded, the unwanted files may be subsequently deleted. The georeferencing system 157 provides the ability to export all files, upload all files, then provides a preview where a user may select and delete unwanted files. Once the land files are uploaded, the georeferencing subsystem 157 links void crop plants and/or crop yields associated with one or more specific locations onto the uploaded land files of the sugarcane field 16 such that void crop plants and/or crop yields are projected onto a map as illustrated by FIGS. 5 and 6B-6C.

These examples of introducing land data into the control unit 68, specifically the georeferencing subsystem 157, are not intended to be limiting upon the present disclosure and, instead, the present disclosure is intended to include other manners of introducing land data into the georeferencing subsystem 157. It should also be understood that the georeferencing subsystem 157 may receive land data from a combination of these land data sources, in any combination, and all such possibilities are intended to be within the spirit and scope of the present disclosure. It should further be understood that the georeferencing subsystem 157 may be associated with one or more devices configured to generate or obtain data itself as described herein.

In another example, the control unit 68 receives, from a user via an input device, a spatial map of their sugarcane field 16 as one or more zone polygons that are clipped to a boundary as a binary spatial coverage file. The binary spatial coverage file may have a variety of forms. In one example, the binary spatial coverage file is in WGS-84 spherical coordinates (i.e., latitude and longitude coordinates). The control unit 68 may import data specific to the field 16 from one of a variety of sources into a GIS environment of the control unit 68. The control unit 68 may then project void crop plants and/or crop yield data into a planar map projection (e.g., a void crop plant layer) in distance units and clean up or smooth, if needed, the geometry topology. The control unit 68 defines a buffer layer which, in some examples, may be larger than the user's input field 16 or land area of interest. The control unit 68 calculates a void crop-signed raster layer which then may be vectorized. In this step, the control unit 68 may apply a predetermined set of rules (e.g., categorization, grouping or classification of void crop plants). The control unit 68 may clean up and smooth resulting void crop plant zone polygons. Clean up may pertain to areas within a zone that are irregularities or errors as compared to surrounding areas within the zone. In one example, smoothing of the void crop plant and/or crop yield zone polygons may be performed for aesthetic purposes to increase user understanding and experience. Such clean up and smoothing may also be performed to provide correct agronomic decision-making and planning, improve performance of a monitor or other visual output device on which the resulting data and associated image may be displayed.

The control unit 68 overlays the void crop plant and/or crop yield zone polygons on the zones inputted by the user to create new zones that are subdivisions of the inputted zones. That is, the lower quantity of inputted zones is further divided to provide multiple new zones within each zone based on void crop plants and/or crop yields. The control unit 68 projects the new void crop plants and/or crop yield zones as spherical coordinates (e.g., latitude and longitude coordinates), cleans-up the geometry of the projection, and writes the file to a binary spatial coverage file. Some monitors only work with latitudinal and longitudinal coordinates so the system may convert the outputted file to latitudinal and longitudinal coordinates.

Sugarcane is shown only as an example and control unit 68 may display any type of crop and any such possibility is intended to be within the spirit and scope of the present disclosure. For example, other possibilities for crops where void crop plant information may be of interest include, but are not limited to, corn, soybeans, potatoes, tomatoes, pumpkins, wheat, barley, sorghum, etc.

Additionally, the void crop plant and/or crop yield zones may be associated and projected with economic indicators or variables such as input costs from, for example, seeds, fertilizer, irrigation, pesticides, etc.; fuel charges; labor costs; etc. The control unit 68 may determine and rely on other economic factors such as, for example, cost per plant (e.g., may be different at different planting rates—bulk discount or efficiency goes up as more plants are planted resulting in lower cost per plant); break even cost; various cost breakdowns of inputs (e.g., fertilizer cost per pass in zone/field, cost of a unit of measure of fertilizer (e.g., pound, etc.), fuel efficiency, etc.); or a wide variety of other factors. In this manner, the control unit 68 may be able to provide optimal results of both agriculture and economics.

The control unit 68 may provide the projections and other data in a variety of manners. The control unit 68 may communicate the projections and data over one or more networks to one or more devices. In one example, the control unit 68 may communicate the projections and/or other data over one or more networks to an operator interface 66 where a user may view the data and/or hear the data. Examples of operator interface 66 include, but are not limited to, personal computers, mobile electronic communication devices, agricultural devices, etc. The control unit 68 may communicate projections and/or other data to the operator interface 66 in a variety of manners including, but not limited to, email, text, automated telephone call, telephone call from a person, a link to a website, etc. In such examples, the control unit 68 may display or audibly produce the projections and/or other data in a variety of manners. For example, the projections and/or communicated data may be in a text format comprised purely of letters, words, and/or sentences. Also, for example, the projections and/or other data may be in a visual or illustrative format. The visual or illustrative format may take on many forms and display a wide variety of types of information. In one example, the visual format may display projections of void crop plants at various stages of growth, including the current growth stage and future growth stages of sugarcane and projections of developmentally delayed plants. The display projections of both void crop plants and developmentally delayed plants may then be further overlaid with other data including soil type, placement at planting, etc.

Further, for example, control unit 68 may communicate the projections and/or other data in a combination of text and visual formats. Examples of the text and illustrations shown include, but are not limited to, the date at which the projection is desired, multiple appearances of the void crop plants at the projection date (e.g., profile and cross-section) and crop yield of the selected land area of interest. Additionally, for example, the control unit 68 may communicate the projections with visual formats only. For example, estimated or projected crop yields are determined by the control unit 68, to illustrate the crop yield in a map format. The control unit 68 may display the map format on a wide variety of devices including, but not limited to, one or more of the operator interface 66 or other devices. In one example, a user may view projections and/or other data at a land area of interest level, which may be comprised of a single zone, a single field including a plurality of zones, a group of fields associated with one another, or any other land area size.

In one example, a user may select via the control unit 68 a group including a plurality of fields. The control unit 68 will provide (in any of the manners described above or alternatives thereof, all of which are intended to be within the sprit and scope of the present disclosure) the projections and/or other data associated with a group. If a group is selected, the projection may include a weighted average sum of the void crop plants and/or crop yields for all the crops included in the selected group of fields. This projection provided at this level by the control unit 68 may be beneficial to a user who manages a large quantity of fields and desires to know their overall void crop plants, developmentally delayed plants, and/or yield. As data inputted into the control unit 68 changes (e.g., weather, inputs, etc.), the void crop plants and/or crop yield may change. The control unit 68 may communicate this change to the operator interface 66 over one or more networks. This communication may also be referred to as an alert. The amount of change necessary to initiate an alert may be any size. In one example, the amount of change may be a unit of measure associated with crop yield.

Referring now to FIG. 6A, the detailed operation of the void crop plant detection and yield sensing system is shown. In FIG. 6A, the various stages of processing and using the plant data are shown in example form. The example shows a segment of one row of sugar cane plants in which plants should have been spaced at regular intervals. This regular, ideal spacing (represented as 504 on FIG. 6C) of each plant is indicated by the hashmarks on row 550. In row 550, the distance between each plant is the same. In the example of FIG. 6A, not all plants are in the preferred locations, nor does every preferred location have a plant. Rows 552 and 554 shows the several cases:
504 Ideal—plant in the ideal location (hashmarks 1, 5, 6, 8, 9);
502 Void—no plant (hashmark 3) or a damaged plant (hashmark 7) in certain location;
Delayed—the plant not quite in its ideal location, either before or after ideal location (hashmark 2); and
506 Double—two plants at a location (hashmark 4).

The row 552 shows the location of each plant as that plant has grown. This location data can be gathered by the void crop plant detection and yield sensing systems described above. Or alternatively, as shown in row 554, the location data may be gathered by cameras or other sensors during field or scouting operations such as spraying the field or fertilizing the field. Alternatively, location data could be collected by a dedicated scout vehicle such as an autonomous terrestrial or aerial robot (i.e. drones).

Row 555a shows sensor sample intervals or windows 555b for each of the plants identified in the as-detected row 552 or as scouted row 554. The term “sensor sample interval or window” or “interval” or “window” as used herein defines a region of time within which control unit 68 is configured to read signals from any of the previously described sensors (e.g., sensors 330 in FIG. 7), to process these signals as indicative of the presence or absence of a plant and/or crop yield, and to save the void crop plant and crop yield data for later use. In this example, outside of the intervals, the control unit 68 is configured to not read signals from the previously described sensors. This illustrates one way in which noise is filtered or rejected by the system.

In another example, the control unit 68 is configured to retrieve data from an a priori plant map as the harvester travels through the field 16. The control unit 68 is configured to compare the location of the harvester and its sensors (which may be provided by GPS 70) with the locations of each plant the harvester is approaching (which is provided by the a priori plant map) and to create an interval based upon this comparison. Knowing the location of the plants and the location of the harvester, the control unit 68 can begin sampling sensors just as (or slightly before) each plant arrives at the harvester, and stop sampling sensors just after the harvester passes over the plant location and the plant has been processed. This starting point and stopping point of sampling defines the sensor sampling interval.

Row 556 shows a filtered plant detection signal originating from one or more of the previously described sensors (e.g., sensors 330 in FIG. 7). The filtering, as has been previously discussed in other examples, removes noise caused by machine vibration, plant leaves, and other extraneous sources. In one example, the filtered signal may be proportional and duration or magnitude to the presence of a sugarcane plant. The control unit 68 is configured to identify a plant (e.g., void crop plant or crop yield) whenever the filtered detection signal from row 556 exceeds a magnitude threshold 558. The control unit 68 output of this thresholding is depicted in row 560 as a series of pulses of varying width. Further, the control unit 68 is configured to classify each of the pulses shown in row 560 according to their width. The output of this classification is shown in row 562. In this example, the control unit 68 is configured to generate a count of each sugarcane plant, and the numerals that comprise row 562 represent the number of identified plants. Finally, the control unit 68 is configured to compile the data it calculated and transmit it to the operator interface 66 as shown in row 564.

Referring now to FIG. 6B, a pictorial view of a field map representing a measured agronomic characteristic such as a crop yield (or, in another example, void crop plants) within field 16 is shown. FIG. 6B shows a pictorial view of a processed field map 510 representing crop yield as sensed and mapped with control unit 68. In one example, control unit 68 has classified the signals according to one of the previously discussed examples and generated crop yield data that, as seen in field map 510 generally indicates less variance between the various portions of the field and the adjusted crop yield values, when compared to the raw data indications. In one example, control unit 68 utilizes bias and smoothing to remove transient characteristics and smooth high-density areas as generally represented by reference numeral 514. Similarly, smoothed low-density areas are generally represented by reference numerals 520 and 522 and a smoothed medium density area is generally represented by reference numeral 516. As such, smoothed high density (e.g. high crop yield) may be represented by regions that are colored red, while smoothed medium density is represented by regions that are colored yellow, and smoothed low density is represented by regions that are colored blue. Field map 510 provides an accurate field map that allows an operator to glean insights relating to the operation of the harvester 10 and the performance of the crop that is harvested. Of course, it is noted that map 510 may be also representative of any of the other previously discussed operational or agronomic parameters herein such as void crop plants as shown in FIG. 6C.

### Exemplary Sugarcane Harvester Control System

FIG. 7 is a high-level illustration of a network environment 300, according to one example embodiment of a sugarcane harvester. The harvester 10 includes a network digital data environment that connects the control unit 68, input controllers 320 and sensors 330 via a network 310.

Various elements connected within of the environment 300 include any number of input controllers 320 and sensors 330 to receive and generate data within the environment 300. The input controllers 320 are configured to receive data via the network 310 or from their associated sensors 330 and control (e.g., actuate) an associated component or their associated sensors. Broadly, sensors 330 are configured to generate data (i.e., measurements) representing a configuration or capability of the harvester 10. A “capability” of the harvester 10, as referred to herein, is, in broad terms, a result of a component action as the harvester 10 manipulates plants (takes actions) in a geographic area such as a field 16. Additionally, a “configuration” of the harvester 10, as referred to herein, is, in broad terms, a current speed, position, setting, actuation level, angle, etc., of a component as the harvester 10 takes actions. A measurement of the configuration and/or capability of a component or the harvester 10 can be, more generally and as referred to herein, a measurement of the “state” of the harvester 10. That is, various sensors 330 can monitor associated components, the field 16, the sugarcane plants, the state of the harvester 10, or any other aspect of the harvester 10.

An agent 340 executing on the control unit 68 inputs the measurements received via the network 310 into a control model 342 as a state vector. Elements of the state vector can include numerical representations of the capabilities or states of the system generated from the measurements. The control model 342 generates an action vector for the harvester 10 predicted by the model 342 to improve harvester 10 performance. Each element of the action vector can be a numerical representation of an action the system can take to manipulate a plant, manipulate the environment, or otherwise affect the performance of the harvester 10. The control unit 68 sends machine commands to input controllers 320 based on the elements of the action vectors. The input controllers 320 receive the machine commands and actuate associated components to take an action. Generally, the action leads to an increase in harvester 10 performance.

In some configurations, control unit 68 can include an operator interface 66 as described previously. The operator interface 66 allows a user to interact with the control unit 68 and control various aspects of the harvester 10. Generally, the operator interface 66 includes an input device and a display device. The input device, can be one or more of a keyboard, button, touchscreen, lever, handle, knob, dial, potentiometer, variable resistor, shaft encoder, or other device or combination of devices that are configured to receive inputs from a user of the system. The display device can be a LED, LCD, plasma display, or other display technology or combination of display technologies configured to provide information about the system to a user of the system. The interface can be used to control various aspects of the agent 340 and model 342.

The network 310 can be any system capable of communicating data and information between elements within the environment 300. In various configurations, the network 310 is a wired network, a wireless network, or a mixed wired and wireless network. In one example embodiment, the network is a controller area network (CAN) and the elements within the environment 300 communicate with each other over a CAN bus.

Referring now to FIG. 8, the model 342 described in herein can also be implemented using an artificial neural network (ANN). That is, the agent 340 executes a model 342 that is an ANN. The model 342 including an ANN determines output action vectors (machine commands) for the harvester 10 using input state vectors 640 (measurements). The ANN has been trained such that determined actions from elements of the output action vectors increase the performance of the harvester 10.

The ANN 600 is based on a large collection of simple neural units 610. A neural unit 610 can be an action (a), a state (s), or any function relating actions (a) and states (s) for the harvester 10. Each neural unit 610 is connected with many others, and connections 620 can enhance or inhibit adjoining neural units 610. Each individual neural unit 610 can compute using a summation function based on all the incoming connections 620. There may be a threshold function or limiting function on each connection 620 and on each neural unit itself 610, such that the neural units 610 signal must surpass the limit before propagating to other neurons. These systems are self-learning and trained, rather than explicitly programmed. Here, the goal of the ANN is to improve harvester 10 performance by providing outputs to carry out actions to interact with an environment, learning from those actions, and using the information learned to influence actions towards a future goal. For example, in one embodiment, a harvester 10 takes a first pass through a field 16 to harvest a crop. Based on measurements of the machine state, the agent 340 determines a reward which is used to train the agent 340. Each pass through the field 16 the agent 340 continually trains itself using a policy iteration reinforcement learning model to improve machine performance.

The neural network of FIG. 8 includes two layers 630: an input layer 630A and an output layer 630B. The input layer 630A has input neural units 610A which send data via connections 620 to the output neural units 610B of the output layer 630B. In other configurations, an ANN can include additional hidden layers between the input layer 630A and the output layer 630B. The hidden layers can have neural units 610 connected to the input layer 630A, the output layer 630B, or other hidden layers depending on the configuration of the ANN. Each layer can have any number of neural units 610 and can be connected to any number of neural units 610 in an adjacent layer 630. The connections 620 between neural layers can represent and store parameters, herein referred to as weights, that affect the selection and propagation of data from a layer's neural units 610 to an adjacent layer's neural units 610. Reinforcement learning may then train the various connections 620 and weights such that the output of the ANN 600 generated from the input to the ANN 600 improves harvester 10 performance. Finally, each neural unit 610 can be governed by an activation function that converts a neural unit's weighted input to its output activation (i.e., activating a neural unit 610 in each layer). Some example activation functions that can be used are: the softmax, identify, binary step, logistic, tan H, Arc Tan, softsign, rectified linear unit, parametric rectified linear, bent identity, sing, Gaussian, or any other activation function for neural networks.

Mathematically, an ANN's function (F(s), as introduced above) is defined as a composition of other sub-functions gᵢ(x), which can further be defined as a composition of other sub-sub-functions. The ANN's function is a representation of the structure of interconnecting neural units 610 and that function can work to increase agent performance in the environment. The function, generally, can provide a smooth transition for the agent towards improved performance as input state vectors 640 change and the agent takes actions.

Most generally, the ANN 600 can use the input neural units 610A and generate an output via the output neural units 6106. In some configurations, input neural units 610A of the input layer 630A can be connected to an input state vector 640 (e.g., s). The input state vector 640 can include any information regarding current or previous states, actions, and rewards of the agent in the environment (state elements 642). Each state element 642 of the input state vector 640 can be connected to any number of input neural units 610A. The input state vector 640 can be connected to the input neural units 610A such that ANN 600 can generate an output at the output neural units 6106 in the output layer 630B. The output neural units 6106 can represent and influence the actions taken by the agent 340 executing the model 342. In some configurations, the output neural units 6106 can be connected to any number of action elements 652 of an output action vector (e.g., a). Each action element can represent an action the agent can take to improve harvester 10 performance. In another configuration, the output neural units 6106 themselves are elements of an output action vector.

This section describes an agent 340 executing a model 342 for improving the performance of a harvester 10, for example with respect to void crop plant detection and crop yield sensing. In this example, model 342 is a reinforcement learning model implemented using an artificial neural net like the ANN of FIG. 8. That is, the ANN includes an input layer 630A including many input neural units 610A and an output layer 630B including many output neural units 610B. Each input neural unit is connected to any number of the output neural units 6106 by any number of weighted connections. The agent 340 inputs measurements of the harvester 10 to the input neural units 610A and the model outputs actions for the harvester 10 to the output neural units 6106. The agent 340 determines a set of machine commands based on the output neural units 6106 representing actions for the harvester that improves harvester 10 performance.

FIG. 9 is a method 700 for generating actions that improve harvester 10 performance using an agent 340 executing a model 342 including an artificial neural net trained using an actor-critic method. Method 700 can include any number of additional or fewer steps, or the steps may be accomplished in a different order.

First, the agent determines 710 an input state vector 640 for the model 342. The elements of the input state vector 640 can be determined from any number of measurements received from the sensors 330 via the network 310. Each measurement is a measure of a state of the machine 10.

Next, the agent inputs 720 the input state vector 640 into the model 342. Each element of the input vector is connected to any number of the input neural units 610A. The model 342 represents a function configured to generate actions to improve the performance of the harvester 10 from the input state vector 640. Accordingly, the model 342 generates an output in the output neural units 6106 predicted to improve the performance of the harvester 10. In one example embodiment, the output neural units 6106 are connected to the elements of an output action vector and each output neural unit 6106 can be connected to any element of the output action vector. Each element of the output action vector is an action executable by a component of the harvester 10. In some examples, the agent 340 determines a set of machine commands for the components based on the elements of the output action vector.

Next, the agent 340 sends the machine commands to the input controllers 320 for their components and the input controllers 320 actuate 730 the components based on the machine commands in response. Actuating 730 the components executes the action determined by the model 342. Further, actuating 730 the components changes the state of the environment and sensors 330 measure the change of the state.

The agent 340 again determines 710 an input state vector 640 to input 720 into the model and determine an output action and associated machine commands that actuate 730 components of the harvester 10 as the harvester 10 travels through the field 16 and harvests plants. Over time, the agent 340 works to increase the performance of the harvester 10 when harvesting plants.

Table 1 describes various states that can be included in an input data vector. Table 1 also includes the associated measurement m of each state, the sensor(s) 330 that generate the measurement m, and a description of the measurement. The input data vector can additionally or alternatively include any other states determined from measurements generated from sensors of the harvester 10. For example, in some configurations, the input state vector 640 can include previously determined states from previous measurements m. In this case, the previously determined states (or measurements) can be stored in memory systems of the control unit 68. In another example, the input state vector 640 can include changes between the current state and a previous state.

TABLE 1
States included in an input vector.

| State (s) | Meas. (m) | Sensor | Description |
|---|---|---|---|
| Separator | # | Primary | Separation characteristics |
| Loss | | Cleaner | including separation of cut crop |
| | | Sensor 76 | and separation of billets |
| | | Secondary | |
| | | Cleaner | |
| | | Sensor 92 | |
| Billet Loss | % | Billet Loss | Number of billets contacting the |
| | | Sensor 74 | load sensor |
| Billet | % | Crop | Amount of damaged billet over |
| Damage | | Processing | amount of usable billet |
| | | Sensor | |
| | | 75 | |
| Leaf Trash | % | Trash Sensor | Amount of leaf impurities in a |
| | | 82 | stream of crop from at least one |
| | | | of the primary cleaner or the |
| | | | secondary cleaner |
| Crop Yield | % | Yield Sensor | Amount of crop in a stream of |
| | | 72 | crop from at least one of the |
| | | | primary cleaner or the secondary |
| | | | cleaner |

Table 2 describes various actions that can be included in an output action vector. Table 2 also includes the machine controller that receives machine commands based on the actions included output action vector, a high-level description of how each input controller 320 actuates their respective components, and the units of the actuation change.

TABLE 2
Actions as an output action vector

| Action (a) | Controller | Description | Units |
|---|---|---|---|
| Ground Speed | Throttle | Change the ground speed of | mph |
| | 11 | the harvester using engine. | |
| Base cutter | Base cutter | Change the speed of the | rpm |
| Speed | 20 | base cutter. | |
| Chopper | Chopper | Change the speed of the | rpm |
| Speed | 28 | chopper. | |
| Lifter | Lifter | Change the speed of the | rpm |
| Speed | 22 | lifter. | |
| Topper | Topper | Change the speed of the | rpm |
| Speed | 24 | topper. | |
| Separator | Separator | Change the separator | inches, |
| | 55 | operation including | rpm |
| | | clearances and speed | |
| Primary cleaner | Fan | Change the speed of the fan | rpm |
| | 40 | | |
| Base cutter | Base cutter | Change the height of the | inches |
| height | 20 | base cutter relative to the | |
| | | ground | |

In one example, the agent 340 is executing a model 342 that is not actively being trained using the reinforcement techniques. In this case, the agent can be a model that was independently trained using the actor-critic methods. That is, the agent is not actively rewarding connections in the neural network. The agent can also include various models that have been trained to optimize different performance metrics of the harvester 10. The user of the harvester 10 can select between performance metrics to optimize, and thereby change the models, using the operator interface 66 of the control unit 68.

In other examples, the agent can be actively training the model 342 using reinforcement techniques. In this case, the model 342 generates a reward vector including a weight function that modifies the weights of any of the connections included in the model 342. The reward vector can be configured to reward various metrics including the performance of the harvester 10 as a whole, reward a state, reward a change in state, etc. In some examples, the user of the harvester 10 can select which metrics to reward using the operator interface 66 of the control unit 68.

FIG. 10 is a block diagram illustrating components of an example machine for reading and executing instructions from a machine-readable medium. Specifically, FIG. 6 shows a diagrammatic representation of network system 310 and control unit 68 in the example form of a computer system 800. The computer system 800 can be used to execute instructions 824 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 800 also includes a main memory 804. The computer system may include a storage unit 816. The processor 802, memory 804, and the storage unit 816 communicate via a bus 808.

In addition, the computer system 800 can include a static memory 806, a graphics display 810 (e.g., to drive a plasma display panel (PDP), a liquid crystal display (LCD), or a projector). The computer system 800 may also include alphanumeric input device 812 (e.g., a keyboard), a cursor control device 814 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. For example, the instructions 824 may include the functionalities of modules of the control unit 68 described in FIG. 2. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 826 via the network interface device 820.

### Additional Considerations

Having described the preferred embodiment, it will become apparent that various modifications can be made without departing from the scope of the invention as defined in the accompanying claims. For example, the trigger function input 238 for specifying the required level of confidence for the signal to indicate a void crop plant or crop yield can be provided by the controller circuit 220 based upon actual crop conditions. Although the harvester 10 is shown as a chopper or cane harvester, the system described above is also suitable for use with other harvesters as well as other implements having interacting and complex adjustments to accommodate various types of continually changing operating conditions. For example, the control unit 68 may communicate projections and/or other data to one or more agricultural machines or devices to assist with controlling the one or more machines or agricultural devices in accordance with the communicated data.

In one example, the control unit 68 may be comprised of one or more of software and/or hardware in any proportion. In such an example, control unit 68 may reside on a computer-based platform such as, for example, a server or set of servers. Any such server or servers may be a physical server(s) or a virtual machine(s) executing on another hardware platform or platforms. Any server, or for that matter any computer-based system, systems or elements described herein, will be generally characterized by one or more control units and associated processing elements and storage devices communicatively interconnected to one another by one or more busses or other communication mechanism for communicating information or data. In one example, storage within such devices may include a main memory such as, for example, a random access memory (RAM) or other dynamic storage devices, for storing information and instructions to be executed by the control unit(s) and for storing temporary variables or other intermediate information during the use of the control unit described herein.

In one example, the control unit 68 may also include a static storage device such as, for example, read only memory (ROM), for storing static information and instructions for the control unit(s). In one example, the control unit 68 may include a storage device such as, for example, a hard disk or solid state memory, for storing information and instructions. Such storing information and instructions may include, but not be limited to, instructions to compute, which may include, but not be limited to processing and analyzing agronomic data or information of all types. Such data or information may pertain to, but not be limited to, weather, soil, water, crop growth stage, pest or disease infestation data, historical data, future forecast data, economic data associated with agronomics or any other type of agronomic data or information.

In one example, the processing and analyzing of data by the control unit 68 may pertain to processing and analyzing agronomic factors obtained from externally gathered image data, and issue alerts if so required based on pre-defined acceptability parameters. RAMs, ROMs, hard disks, solid state memories, and the like, are all examples of tangible computer readable media, which may be used to store instructions which comprise processes, methods and functionalities of the present disclosure. Exemplary processes, methods and functionalities of the control unit 68 may include determining a necessity for generating and presenting alerts in accordance with examples of the present disclosure. Execution of such instructions causes the various computer-based elements of control unit 68 to perform the processes, methods, functionalities, operations, etc., described herein. In some examples, the control unit 68 of the present disclosure may include hard-wired circuitry to be used in place of or in combination with, in any proportion, such computer-readable instructions to implement the disclosure.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the systems, methods, processes, apparatuses and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the systems, apparatuses, devices, methods and/or processes via the use of block diagrams, schematics, flowcharts, examples and/or functional language. Insofar as such block diagrams, schematics, flowcharts, examples and/or functional language contain one or more functions and/or operations, it will be understood by those within the art that each function and/or operation within such block diagrams, schematics, flowcharts, examples or functional language can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the signal bearing medium used to carry out the distribution. Examples of a signal bearing medium include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components associated with, comprised of, contained within or connected with different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two or more components herein combined to achieve a particular functionality can be seen as “associated with” each other such that the desired functionality is achieved, irrespective of architectures or intermediate components. Likewise, any two or more components so associated can also be viewed as being “operably connected”, or “operably coupled”, to each other to achieve the desired functionality, and any two or more components capable of being so associated can also be viewed as being “operably couplable”, to each other to achieve the desired functionality. Specific examples of operably couplable include, but are not limited to, physically mateable and/or physically interacting components, and/or wirelessly interactable and/or wirelessly interacting components, and/or logically interacting and/or logically interactable components.

Unless specifically stated otherwise or as apparent from the description herein, it is appreciated that throughout the present disclosure, discussions utilizing terms such as “accessing,” “aggregating,” “analyzing,” “applying,” “brokering,” “calibrating,” “checking,” “combining,” “communicating,” “comparing,” “conveying,” “converting,” “correlating,” “creating,” “defining,” “deriving,” “detecting,” “disabling,” “determining,” “enabling,” “estimating,” “filtering,” “finding,” “generating,” “identifying,” “incorporating,” “initiating,” “locating,” “modifying,” “obtaining,” “outputting,” “predicting,” “receiving,” “reporting,” “retrieving,” “sending,” “sensing,” “storing,” “transforming,” “updating,” “using,” “validating,” or the like, or other conjugation forms of these terms and like terms, refer to the actions and processes of a control unit, computer system or computing element (or portion thereof) such as, but not limited to, one or more or some combination of: a visual organizer system, a request generator, an Internet coupled computing device, a computer server, etc. In one example, the control unit, computer system and/or the computing element may manipulate and transform information and/or data represented as physical (electronic) quantities within the control unit, computer system's and/or computing element's processor(s), register(s), and/or memory(ies) into other data similarly represented as physical quantities within the control unit, computer system's and/or computing element's memory(ies), register(s) and/or other such information storage, processing, transmission, and/or display components of the computer system(s), computing element(s) and/or other electronic computing device(s). Under the direction of computer-readable instructions, the control unit, computer system(s) and/or computing element(s) may carry out operations of one or more of the processes, methods and/or functionalities of the present disclosure.

Those skilled in the art will recognize that it is common within the art to implement apparatuses and/or devices and/or processes and/or systems in the fashion(s) set forth herein, and thereafter use engineering and/or business practices to integrate such implemented apparatuses and/or devices and/or processes and/or systems into more comprehensive apparatuses and/or devices and/or processes and/or systems. That is, at least a portion of the apparatuses and/or devices and/or processes and/or systems described herein can be integrated into comprehensive apparatuses and/or devices and/or processes and/or systems via a reasonable amount of experimentation.

Although the present disclosure has been described in terms of specific embodiments and applications, persons skilled in the art can, considering this teaching, generate additional embodiments without exceeding the scope or departing from the spirit of the present disclosure described herein. Accordingly, it is to be understood that the drawings and description in this disclosure are proffered to facilitate comprehension of the present disclosure, and should not be construed to limit the scope thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

What is claimed is:

1. A method for mapping an agricultural crop in a field, the method comprising:
receiving signals, with a control unit mounted on an agricultural work machine, from a yield sensor, which senses a yield characteristic of the crop, and a processing sensor, which senses a processing characteristic of the crop, associated with an agricultural work machine;
determining the presence of a void crop plant using the received signals;
determining a location of the void crop plant using at least a time and a location of the agricultural work machine; and
generating a void crop map showing the location of the void crop plant within the field.

2. The method of claim 1 further comprising the step of classifying the received signals using at least one of a fuzzy logic, machine learning, clustering, or statistical analysis classification system.

3. The method of claim 2 wherein the step of classifying the received signal is performed using a fuzzy logic system wherein a confidence factor is assigned to each of the received signals associated with the yield sensor and processing sensor for a sampling interval.

4. The method of claim 3 further comprising determining the presence of a void crop plant for the sampling interval using the received signals and at least one of the associated confidence factors.

5. The method of claim 4 further comprising determining an aggregate confidence indicator for the presence of a void crop plant based on the confidence factors related to an estimated accurateness of the received signals.

6. The method of claim 5 wherein the accurateness of the received signal is based on at least one of (i) a range of the at least one of the received signals, (ii) a change rate of the at least one of the received signals, (iii) a noise level of the at least one of the received signals and (iv) a plant loss condition, wherein the plant loss condition is associated with at least one of a void crop plant, pest damage, weed damage, field operation damage, and drought.

7. The method of claim 1 wherein the crop is sugarcane and the agricultural work machine is a sugarcane harvester.

8. The method of claim 1 wherein the processing characteristic from the processing sensor corresponds to a sensed characteristic associated with at least one of base cutter pressure, chopper pressure, and elevator speed.

9. The method of claim 1 wherein the yield sensor is within a stream of processed material of the agricultural work machine, the yield sensor sensing a yield characteristic corresponding to a mass or a volume of the processed d material.

10. The method of claim 1 further comprising conditioning the signals by applying at least one of a filter, delay, scaling, offset and bias removal.

11. The method of claim 1 further comprising receiving signals from at least one of a satellite navigation receiver or a location-determining receiver, each receiver producing a time, position, and velocity of the agricultural work machine.

12. The method of claim 1 wherein the step of determining the presence of a void crop plant further comprises:
analyzing whether the received signals have a void crop characteristic; and
assigning a confidence indicator to each of the received signals with the void crop characteristic.

13. The method of claim 12 wherein the void crop characteristic indicates at least one of a void crop plant or a developmentally delayed plant.

14. The method of claim 1 wherein the step of generating a void crop map is performed with a processor, the processor located either onboard the agricultural work machine or offboard the agricultural work machine and the onboard or offboard generation of the void crop map occurring as the agricultural work machine moves through the field or subsequent to the agricultural work machine moving through field.

15. The method of claim 1 further comprising generating, using the void crop map, at least one of a planting field operation prescription, harvest field operation prescription, and a crop care field operation prescription.

16. The method of claim 15 wherein the planting field operation prescription includes replanting a void crop plant.

17. The method of claim 15 wherein the harvest field operation prescription includes adjusting at least one of a speed, cleaning settings or engine management of harvester.

18. The method of claim 15 wherein the crop care field operation prescription includes adjusting the operation of a sprayer, cultivator or fertilizer.

19. A system for mapping the location of void crop plants in a field, the system comprising:
an agricultural working machine;
at least two sensors associated with agricultural working machine; and
a data processor configured to determine the presence of a void crop plant using the received signals from the at least two sensors and generate a void crop plant map, the map showing the location of a void crop plant within the field.

20. The system of claim 19 wherein the at least two sensors are configured to sense parameters relating to at least one of the crop in the field or the agricultural work machine.
